(19) United States
(12) Patent Application Publication
(10) Pub. No.: US 2006/0160940 A1
(43) Pub. Date: Jul. 20, 2006

(54) Process for intercalating natural or szynthetic clays with block or comb copolymers

(76) Inventors: Andreas Muhlebach, FRICK (CH); Francois Rime, Delemont (CH)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/547,265

(22) PCT Filed: Feb. 23, 2004
(86) PCT No.: PCT/EP04/50184

§ 371 Date: Aug. 29, 2005

(30) Foreign Application Priority Data
Mar. 3, 2003 (EP) 03405139.1

(51) Int. Cl. C08K 3/34; C08L 53/00; B32B 27/00

(52) U.S. Cl. 524/445

(57) ABSTRACT

The instant invention relates to a process for manufacturing nanoparticles by intercalating and/or exfoliating natural or synthetic clays using block or comb copolymers having one cationic block and at least one non polar block, which are prepared by controlled free radical polymerization (CFRP). The invention also relates to improved nanocomposite compositions containing nanoparticles produced by this process and to the use of these nanocomposite compositions as, for example in, coatings, sealants, caulks, adhesives and as plastic additives.

The instant invention relates to a process for manufacturing nanoparticles by intercalating and/or exfoliating natural or synthetic clays using block or comb copolymers having one cationic block and at least one non polar block, which are prepared by controlled free radical polymerization (CFRP). The invention also relates to improved nanocomposite compositions containing nanoparticles produced by this process and to the use of these nanocomposite compositions as, for example, in coatings, sealants, caulks, adhesives and as plastic additives.

One way of improving polymer properties is by adding a natural or synthetic clay material to polymers to form composite materials. However, incorporating clays into polymers may got provide a desirable improvement in the physical properties, particularly mechanical and optical properties of the polymer may be adversely affected.

Nanonocomposite compositions containing finely dispersed natural or synthetic clay with at least partially intercalated and/or exfoliated layers and mixtures of ethylenically unsaturated monomers and/or polymers therefrom have therefore attracted much interest in the last years. These materials combine the desired effects of dispersed clay by avoiding the negative influence on, for example, the mechanical or optical properties.

Such compositions, methods for making them and their use in polymers and coatings are for example described in WO 02/24759. Polymerization processes are described using montmorillonite clay, acrylate monomers and for example ammonium persulfate as radical initiator. This conventional polymerization process leads to polymers with broad molecular weight distributions and a high polydispersity index (PD).

Another approach is, for example described by Yang et al. in Mat. Res. Soc. Symp. Proc. Vol. 703, 2002, pages 547-552. Di- or triblock copolymers are prepared containing dimethyl-aminoethyl methacrylate as monomer in one block and, for example, methacrylic acid as monomer in the other block. From these copolymers cationic blocks are obtained by protonating the aminoblock in the copolymer. The protonated blockcopolymers are then used for intercalating montmorillonite. The D-spading between the layers is typically between 1.5 and 2 nm. There is nothing disclosed, as to how the preparation of the block copolymers is carried out, in particular, the polydispersity index M_{W}/Mₙ of the individual blocks and of the total block copolymer is not known.

The instant invention provides improved nanoparticles of natural and synthetic clay, having in general higher D-spacings. The nanoparticles are prepared by intercalating and/or exfoliating natural or synthetic clays using block or comb copolymers having one cationic block and at least one non polar block, which copolymers are prepared by controlled free radical polymerization (CFRP).

Controlled free radical polymerization per se is known and can be carried out by using for example atom transfer radical polymerization (ATRP) as described in WO 96/30421. WO 96/30421 discloses a controlled or “living” polymerization process of ethylenically unsaturated monomers such as styrene or (meth)acrylates by employing the ATRP method. According to this method initiators are employed which generate a radical atom such as .Cl, in the presence of a redox system of transition metals of different oxidation states, e.g. Cu(I) and Cu(II), providing “living” or controlled radical polymerization.

Another further suitable polymerization process is disclosed in U.S. Pat. No. 4,581,429. U.S. Pat. No. 4,581,429 discloses a free radical polymerization process by controlled or “living” growth of polymer chains which produces defined oligomeric homopolymers and copolymers, including block and graft copolymers. Disclosed is the use of initiators of the partial formula R′R″N—O—X. In the polymerization process the free radical species R′R″N—O. and .X are generated. .X is a free radical group, e.g. a tert.-butyl or cyanoisopropyl radical, capable of polymerizing monomer units containing ethylene groups.

A variation of the above process s disclosed in U.S. Pat. No. 5,322,912 wherein the combined use of a free radical initiator and a stable free radical agent of the basic structure R′R″N—O. for the synthesis of homopolymers and block copolymers is described.

All three processes are useful for the preparation of blocker comb copolymers wherein the block copolymers have a narrow molecular weight distribution and hence a low polydispersity index.

Surprisingly it has been found, that clay nanoparticles prepared from block- or comb copolymers obtained by CFRP are not only intercalated but in many cases exfoliated and therefore dispersions containing these nanoparticles are much more storage stable. In most cases there is no agglomeration or aggregation even after long storage periods. The nanocomposite compositions of the instant invention can be optically almost transparent, indicating the fine distribution, on the nanometer scale, of the clay.

One aspect of the invention is a process for preparing a block- or comb polymer, clay nanocomposite dispersion comprising
mixing an aqueous dispersion of a natural or synthetic clay having an exchangeable cation; with
a block copolymer having a cationic block A wherein the cation is based on at least one nitrogen atom, and a nonionic block B, both blocks having a polydispersity between 1 and 3, or
a comb copolymer having a cationic backbone A wherein the cation is based on a nitrogen atom and nonionic oligomeric/polymeric chains B attached thereto, the cationic backbone A having a polydispersity between 1 and 3 and the nonionic side chains having a polydispersity of 1.0-1.8;
wherein the block copolymer is obtained
   a1) by polymerizing in a first step an ethylenically unsaturated monomer in the presence of at least one nitroxylether having the structural element 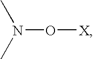
wherein X represents a group having at least one carbon atom and is such that the free radical X. derived from X is capable of initiating polymerization and adding in a second step to the resulting macromer, which has attached a labile bound 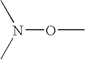
group, a further ethylenically unsaturated monomer different from that in step 1,
   with the proviso that at least one monomer in the first or second step contains a cation centered on a nitrogen atom or a nitrogen atom from which a cation can be formed; or
   a2) by polymerzing in a first step an ethylenically unsaturated monomer in the presence of at least one stable free nitroxyl radical 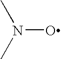
and a free radical initiator and adding in a second step to the resulting macromer, which has attached a labile bound 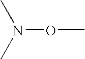
group, a further ethylenically unsaturated monomer different from that in step 1;
   with the proviso that at least one monomer in the first or second stop contains a cation centered on a nitrogen atom or a nitrogen atom from which a cation can be formed; or
   a3) by polymerzing in a first step an ethylenically unsaturated monomer in the presence of a compound of formula (III) 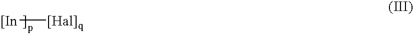
and a catalytically effective amount of an oxidizable transition metal complex catalyst, wherein
   p represents a number greater than zero and defines the number of initiator fragments;
   q represents a number greater than zero;
   [In] represents a radically transferable atom or group capable of initiating polymerization and
   [Hal] represents a leaving group; and adding in a second step to the resulting macromer a further ethylenically unsaturated monomer different from that in step one;
   with the proviso that at least one monomer in the first or second step contains a cation centered on a nitrogen atom or a nitrogen atom from which a cation can be formed;
wherein the comb copolymer is obtained
   by polymerizing in a first step an ethylenically unsaturated monomer in the presence of a compound of formula (III) 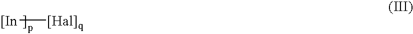
and a catalytically effective amount of an oxidizable transition metal complex catalyst, wherein the symbols have the meanings as defined above;
   exchanging the group [HAL] attached to the polymer with a group having an ethylenically unsaturated bond and subjecting the resulting macromer together with a second monomer, which contains a nitrogen based cation or a nitrogen atom from which a cation can be formed, to radical polymerization;
forming the nitrogen based cation if necessary and exchanging the cation in the natural or synthetic clay, with the nitrogen based cationic block or comb copolymer and intercalating and/or exfoliating the clay at least partially.

If the clay material is a synthetic one, it may be produced by gas-phase or sol-gel processes, for example Optigel® from Süd Chemie.

Natural clay minerals are typically comprised of hydrated aluminum silicates that are fine-grained and have a platy habit. The crystalline structure of a typical clay mineral is a multi-layered structure comprised of combinations of layers of SiO₄ tetrahedra that are joined to layers of AlO(OH)₂ octahedra. A so called “gallery” is formed which describes the defined interlayer spaces of the layered clay minerals. Depending of the clay mineral the gallery may contain water and/or other constituents such as potassium, sodium or calcium cations. Clay minerals vary, based upon the combination of their constituent layers and cations. Isomorphic substitution of the cations of clay mineral, such as Al³⁺ or Fe³⁺ substituting for the Si⁴⁺ ions in the tetrahedral network, or Al³⁺, Mg²⁺ or Fe²⁺ substituting for other cations in the octahedral network, typically occurs and may impart a net negative charge on the clay structure. Natural occurring elements within the gallery of the clay, such as water molecules or sodium or potassium cations, are attracted to the surface of the clay layers due to this net charge.

Nanocomposites are compositions in which at least one of its constituents has one or more dimensions, such as length, width or thickness in the nanometer size range. The term nanocomposite, as used herein, denotes the state of matter wherein intercalated and at least partially exfoliated clay layers are surrounded by a polymer matrix.

The term “intercalated nanocomposite”, as used herein describes a nanocomposite that contains a regular insertion between the clay layers.

The term “exfoliated nanocomposite” as used herein describes a nanocomposite wherein the a few nm thick layers of clay with polymer molecules attached to K are dispersed in the matrix (oligomer/polymer) forming a composite structure on the nano/micro scale.

The clay minerals are items of commerce and are for example supplied by Süd-Chemie Inc., Germany or Nanocore, USA.

The natural or synthetic clay is for example a phyllosilicate.

In particular the natural clay is selected from the group consisting of smectite, montmorillonite, saponite, beidellite, mica, sauconite, ledikite, montronite, hectorite, stevensite, vermiculite, kaolinite, hallosite and combinations thereof.

Special preference is given to montmorillonite.

As already mentioned it is indispensable that the block copolymers are prepared by controlled free radical polymerization (CFRP). There are essentially three suitable routes:

a1) polymerization in the presence of alkoxyamine initiator/regulator compounds;

a2) polymerization in the presence of a stable nitroxyl free radical and a radical initiator (source of free radicals) and

a3) polymerization under atom transfer radical polymerization (ATRP) conditions. All three routes are known and widely described.

For example the structural element 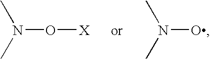
may be part of a cyclic ring system or substituted to form a acyclic structure.

Suitable nitroxylethers and nitroxyl radicals are principally known from U.S. Pat. No. 4,581,429 or EP-A-621 878. Particularly useful are the open chain compounds described in WO O8/13392, WO 99/03894 and WO 00/07981, the piperidine derivatives described in WO 99/67298 and GB 2335190 or the heterocyclic compounds described in GB 2342649 and WO 96/24620. Further suitable nitroxylethers and nitroxyl radicals are described in WO 02/4805 and in WO 021100831.

Stable free radicals having a structural element 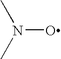
are for example disclosed in EP-A-621 878.

### Examples, such as

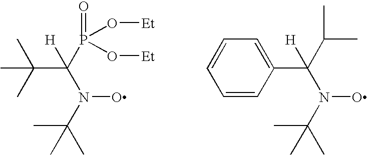 are for example given in WO 96/24620.

Preferably the structural element 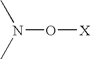
is a structural element of formula (I)

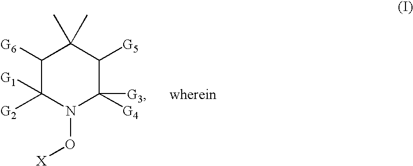

G₁, G₂, G₃, G₄ are independently C₁-C₆alkyl or G₁ and G₂ or G₃ and G₄, or G₁ and G₂ and G₃ and G₄ together form a C₅-C₁₂cycloalkyl group;

G₅, G₆ independently are H, C₁-C₁₈alkyl, phenyl, naphthyl or a group COOC₁-C₁₈alkyl.

In particular the structural element of formula (I) is of formula A, B or O,

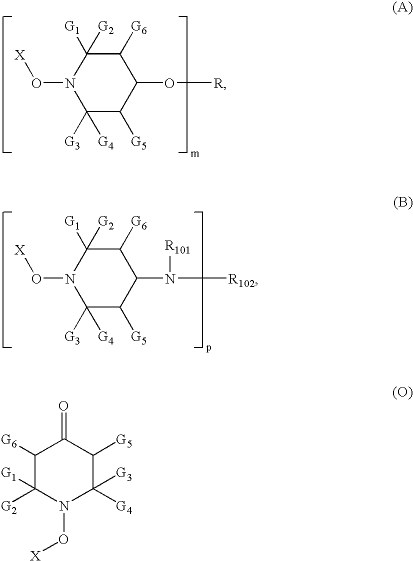

wherein

m is t,

R is hydrogen, C₁-C₁₈alkyl which is uninterrupted or interrupted by one or more oxygen atoms, cyanoethyl, benzoyl, glycidyl, a monovalent radical of an aliphatic carboxylic acid having 2 to 18 carbon atoms, of a cycloaliphatic carboxylic acid having 7 to 15 carbon atoms, or an α,β-unsaturated carboxylic acid having 3 to 5 carbon atoms or of an aromatic carboxylic acid having 7 to 15 carbon atoms;

p is 1;

R₁₀₁ is C₁-C₁₂alkyl, C₅-C₇cycloalkyl, C₇-C₈aralkyl, C₂-C₁₈alkanoyl, C₃-C₅alkenoyl or benzoyl;

R₁₀₂ is C₁-C₁₈alkyl, C₅-C₇cycloalkyl, C₂-C₈alkenyl unsubstituted or substituted by a cyano, carbonyl or carbamide group, or is glycidyl, a group of the formula —CH₂CH(OH)-Z or of the formula —CO-Z or —CONH-Z wherein Z is hydrogen, methyl or phenyl;

G₆ is hydrogen and G₅ is hydrogen or C₁-C₄alkyl,

G₁ and G₃ are methyl and G₂ and G₄ are ethyl or propyl or G₁ and G₂ are methyl and G₃ and G₄ are ethyl or propyl; and

X is selected from the group consisting of

—CH₂-phenyl, CH₃CH-phenyl, (CH₃)₂C-phenyl, (C₆-C₉cycloalkyl)₂CCN, (CH₃)₂CCN, 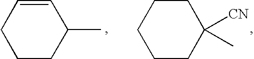
—CH₂CH═CH₂, CH₃CH—CH=CH₂ (C₁-C₄alkyl)CR₂₀—C(O)— phenyl, (C₁-C₄)alkyl-CR₂₀—C(O)—(C₁-C₄)alkyl, (C₁-C₄)alkyl-CR₂₀—C(O)—(C₁-C₄)alkyl, (C₁-C₄)alkyl-CR₂₀—C(O—N-di(C₁-C₄)alkyl, (C₁-C₄)alkyl-CR₂₀—C(O)—NH(C₁-C₄)alkyl, (C₁-C₄)alkyl-CR₂₀-C(O)—NH₂, wherein

R₂₀ is hydrogen or (C₁-C₄)alkyl.

The above compounds and their preparation are described in GB 2335190 and GB 2 361 235.

Another preferred group of nitroxylethers of step al) are those of formula (Ic), (Id), (Ie), (If)ᵢ (Ig) or (Ih)

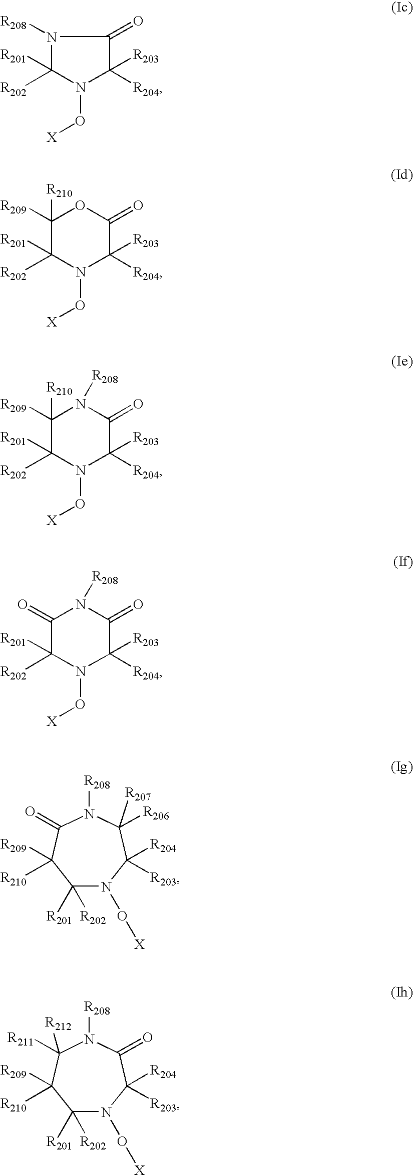

wherein R₂₀₁, R₂₀₂, R_{R}₂₀₃ and R₂₀₄ independently of each other are C₁-C₁₈alkyl, C₃-C₁₈alkenyl, C₃-C₁₈alkinyl, C₁-C₁₈alkyl, C₃-C₁₈alkenyl, C₃-C₁₈alkinyl which are substituted by OH, halogen or a group —O—C(O)—R₂₀₅, C₂-C₁₈alkyl which is interrupted by at least one O atom and/or NR₂₀₅ group, C₃-C₁₂cycloalkyl or C₅-C₁₀aryl or R₂₀₁ and R₂₀₂ and/or R₂₀₃ and R₂₀₄ together with the linking carbon atom from a C₃-C₁₂cycloalkyl radical;

R₂₀₅, R₂₀₆ and R₂₀₇ independently are hydrogen, C₁-C₁₈alkyl or C₆-C₁₀aryl;

R₂₀₃ is hydrogen, OH, C₁-C₁₈alkyl, C₃-C₁₈alkenyl, C₃-C₁₈alkinyl, C₁-C₁₈alkyl, C₃-C₁₈alkenyl, C₃-C₁₈alkinyl which are substituted by one or more OH, halogen or a group —O—C(O)—R₂₀₅, C₂-C₁₈alkyl which is interrupted by at least one O atom and/or NR₂₀₆ group, C₃-C₁₂cycloalkyl or C₆-C₁₀aryl, C₇-C₈phenylalkyl, C₆-C₁₀heteroaryl, —C(O)—C₁-C₁₈alkyl, —O—C₁-C₁₈alkyl or —COOC₁-C₁₈alkyl;

R₂₀₉, R₂₁₀, R₂₁₁ and R₂₁₂ are independently hydrogen, phenyl or C₁-C₁₈alkyl; and

X is selected from the group consisting of —CH₂-phenyl, CH₃CH-phenyl, (CH₃)₂C-phenyl, (C₅-C₆cycloalkyl)₂CCN, (CH₃)₂CNN, 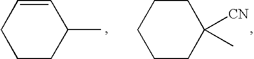
—CH₂CH═CH₂, CH₃CH—CH═CH₂(C₁-C₄alkyl)CR₂₀-C(O)-phenyl, (C₁-C₄)alkyl-CR₂₀—C(O)—(C₁-C₄)alkoxy, (C₁-C₄)alkyl-CR₂₀—C(O)—(C₁-C₄)alkyl, (C₁-C₄)alkyl-CR₂₀—C(O)—N-di(C₁-C₄)alkyl, (C₁-C₄)alkyl, (C₁-C₄)alkyl-CR₂₀—C(O)—NH(C₁-C₄)alkyl, (C₁-C₄)alkyl-CR₂₀—C(O)—NH₂, wherein

R₂₀ is hydrogen or (C₁-C₄)alkyl.

More preferably in formula (Ic), (Id), (Ie), (f), (Ig), and (Ih) at least two of R₂₀₁, R₂₀₂, R₂₀₃ and R₂₀₄ are ethyl, propyl or butyl and the remaining are methyl; or

R₂₀₁ and R₂₀₂ or R₂₀₃ and R₂₀₄ together with the linking carbon atom from a C₅-C₆cycloalkyl radical and one of the remaining substituents is ethyl, propyl or butyl.

Most preferably X is CH₃CH-phenyl.

The above compounds and their preparation is described in GB 2342649.

Further suitable compounds are the 4-imino compounds of formula (II)

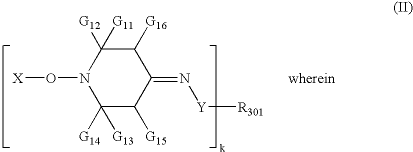

G₁₁, G₁₂, G₁₃ and G₁₄ are independently C₁-C₄alkyl or G₁₁ and G₁₂ together and G₁₃ and G₁₄ together, or G₁₁ and G₁₂ together or G₁₃ and G₁₄ together are pentamethylene;

G₁₅ and G₁₆ are each independently of the other hydrogen or C₁-C₄alkyl;

X is as defined above;

It is 1, 2, 3, or 4

Y is O, NR₃₀₂ or when n is 1 and R₃₀₁ represents alkyl or aryl Y is additionally a direct bond;

R₃₀₂ is H, C₁-C₁₈alkyl or phenyl;

if k is 1

R₃₀₁ is H, straight or branched C₁-C₁₈alkyl, C₃-C₁₈alkenyl or C₃-C₁₈alkinyl, which may be unsubstituted or substituted, by one or more OH, C₁-C₈alkoxy, carboxy, C₁-C₈alkoxycarbonyl;

C₆-C₁₂cycloalkyl or C₅-C₁₂cycloalkenyl;

phenyl, C₇-C₉phenylalkyl or naphthyl which may be unsubstituted or substituted by one or more C₁-C₈alkyl, halogen, OH, C₁-C₈alkoxy, carboxy, C₁-C₈alkoxycarbonyl;

—C(O)C—C₁-C₁₈alkyl, or an acyl moiety of a c,unsaturated carboxylic acid having 3 to 5 carbon atoms or of an aromatic carboxylic acid having 7 to 15 carbon atoms;

—SO₃⁻Q⁺, —PO(OR₂)₂, —P(O)(OR₂)₂—SO₂—R₂, —CO—NH—R₂, —CONH₂, COOR₂, or Si(Me)₃, wherein Q⁺ is H⁺, ammonium or an alkali metal cation;

if k is 2

R₃₀₁ is C₁-C₁₈alkylene, C₃-C₁₈alkenylene or C₃-C₁₈alkinylene, which may be unsubstituted or substituted, by one or more OH, C₁-C₈alkoxy, carboxy, C₁-C₈alkoxycarbonyl;

or xylylene; or

R₃₀₁ is a bisacyl radical of an aliphatic dicarboxylic acid having 2 to 36 carbon atoms, or a cycloaliphatic or aromatic dicarboxylic acid having 8-14 carbon atoms;

if k is 3,

R₃₀₁ is a trivalent radical of an aliphatic, cycloaliphatic or aromatic tricarboxylic acid; and

if k is 4, R₃₀₁ is a tetravalent radical of an aliphatic, cycloaliphatic or aromatic tetracarboxylic acid.

Preferably G₁₅ is hydrogen and G₁₆ is hydrogen or C₁-C₄alkyl, in particular methyl, and G₁₁ and G₁₃ are methyl and G₁₂ and G₁₄ are ethyl or propyl or G₁₁ and G₁₂ are methyl and G₁₃ and G₁₄ are ethyl or propyl.

The 4 imino compounds of formula V can be prepared for example according to E. G. Rozantsev, A. V. Chudinov, V. D. Sholle. :lzv. Aked. Nauk. SSSR, Ber. Khim. (9), 2114 (1980), starting from the corresponding 4-oxonitroxide in a condensation reaction with hydroxylamine and subsequent reaction of the OH group. The compounds are described WO 021100831.

When the polymerization process is carried out according to route a2) the structural element 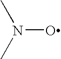
is for example a structural element of formula (I′)

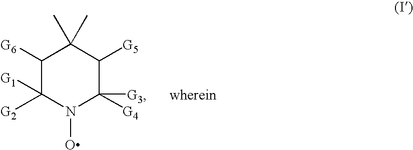

G₁, G₂, G₃, G₄ are independently C₁-C₆alkyl or G₁ and G₂ or G₃ and G₄, or G₁ and G₂ and G₃ and G₄ together form a C₅-C₁₂cycloalkyl group;

G₅, G₆ independently are H, C₁-C₁₈alkyl, phenyl, naphthyl or a group COOC₁-C₁₈alkyl.

Preference is given to compounds wherein the structural element of formula (I′) is of formula A′, B′ or O′,

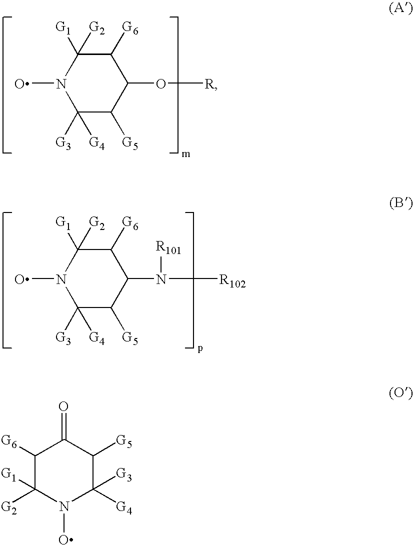

wherein

m is 1,

R is hydrogen, C₁-C₁₈alkyl which is uninterrupted or interrupted by one or more oxygen atoms, cyanoethyl, benzoyl, glycidyl, a monovalent radical of an aliphatic carboxylic acid having 2 to 18 carbon atoms, of a cycloaliphatic carboxylic acid having 7 to 15 carbon atoms, or an α,β-unsaturated carboxylic acid having 3 to 5 carbon atoms or of an aromatic carboxylic acid having 7 to 15 carbon atoms;

p is 1;

R₁₀₁ is C₁-C₁₂alkyl, C₆-C₇cycloalkyl, C₇-C₈aralkyl, C₂-C₁₈alkanoyl, C₃-C₆alkenoyl or benzoyl;

R₁₀₂ is C₁-C₁₈alkyl, C₅-C₇cycloalkyl, C₂-C₈alkenyl unsubstituted or substituted by a cyano, carbonyl or carbamide group, or is glycidyl, a group of the formula —CH₂CH(OH)-Z or of the formula —CO-Z or —CONH-Z wherein Z is hydrogen, methyl or phenyl;

G₆ is hydrogen and G₅ is hydrogen or C₁-C₆alkyl,

G₁ and G₃ are methyl and G₂ and G₄ are ethyl or propyl or G₁ and G₂ are methyl and G₃ and G₄ are ethyl or propyl.

Also suitable are the compounds wherein the structural element 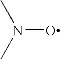
is of formula (II′)

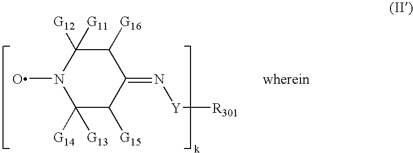

G₁₁, G₁₂, G₁₃ and G₁₄ are independently C₁-C₄alkyl or G₁₁ and G₁₂ together and G₁₃ and G₁₄ together, or G₁₁ and G₁₂ together or G₁₃ and G₁₄ together are pentamethylene;

G₁₅ and G₁₆ are each independently of the other hydrogen or C₁-C₄alkyl;

k is 1, 2, 3, or 4

Y is 0, NR₃₀₂ or when n is 1 and R₃₀₁ represents alkyl or aryl Y is additionally a direct bond;

R3m is H, C₁-C₁₈alkyl or phenyl;

if k is 1

R₃₀₁ is H, straight or branched C₁-C₁₈alkyl, C₃-C₁₈alkenyl or C₃-C₁₈alkinyl, which may be unsubstituted or substituted, by one or more OH, C₁-C₈alkoxy, carboxy, C₁-C₁₈alkoxycarbonyl;

C₅-C₁₂cycloalkyl or C₅-C₁₂cycloalkenyl;

phenyl, C₇-C₉phenylalkyl or naphthyl which may be unsubstituted or substituted by one or more C₁-C₈alkyl, halogen, OH, C₁-C₈alkoxy, carboxy, C₁-C₈alkoxycarbonyl;

—C(O)—C₁-C₃₃alkyl, or an acyl moiety of a α,β-unsaturated carboxylic acid having 3 to 5 carbon atoms or of an aromatic carboxylic acid having 7 to 15 carbon atoms;

—SO₃⁻Q⁺, —PO(O⁻Q⁺)₂, —P(O)(OR₂)₂, —SO₂—R₂, —CO—NH—R₂, —CONH₂, COOR₂, or Si(Me)₃, wherein Q⁺ is H⁺, ammonium or an alkali metal cation;

if k is 2

R₃₀₁ is C₁-C₁₈alkylene, C₃-C₁₈alkenylene or C₃-C₁₈alkenylene, which may be unsubstituted or substituted, by one or more OH, C₁-C₈alkoxy, carboxy, C₁-C₈alkoxycarbonyl;

or xylylene; or

R₃₀₁ is a bisacyl radical of an aliphatic dicarboxylic acid having 2 to 36 carbon atoms, or a cycloaliphatic or aromatic dicarboxylic acid having 8-14 carbon atoms;

if k is 3,

R₃₀₁ is a trivalent radical of an aliphatic, cycloaliphatic or aromatic tricarboxylic acid; and

if k is 4, R₃₀₁ is a tetravalent radical of an aliphatic, cycloaliphatic or aromatic tetracarboxylic acid.

The alkyl radicals in the various substituents may be linear or branched. Examples of alkyl containing 1 to 18 carbon atoms are methyl, ethyl, propyl, isopropyl, butyl, 2-butyl, isobutyl, t-butyl, pentyl, 2-pentyl, hexyl, heptyl, octyl, 2-ethylhexyl, t-octyl, nonyl, decyl, undecyl, dodecyl, tridecyl, tetradecyl, hexadecyl and octadecyl.

Alkenyl with 3 to 18 carbon atoms is a linear or branched radical as for example propenyl, 2-butenyl, 3-butenyl, isobutenyl, n-2,4-pentadienyl, 3-methyl-2-butenyl, n-2-octenyl, n-2-dodecenyl, iso-dodecenyl, oleyl, n-2-octadecenyl oder n-4-octadecenyl.

Preferred is alkenyl with 3 bis 12, particularly preferred with 3 to 6 carbon atoms.

Alkenyl with 3 to 18 is a linear or branched radical as for example propinyl 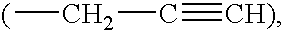
2-butinyl, 3-butinyl, n-2-octinyl, oder n-2-octadecinyl. Preferred is alkinyl with 3 to 12, particularly preferred with 3 to 6 carbon atoms.

Examples for hydroxy substituted alkyl are hydroxy propyl, hydroxy butyl or hydroxy hexyl.

Examples for halogen substituted alkyl are dichloropropyl, monobromobutyl or trichlorohexyl.

C₂-C₁₈alkyl interrupted by at least one O atom is for example —CH₂—CH₂—O—CH₂—CH₃, —CH₂—CH₂—O—CH₃— or —CH₂—CH₂—O—CH₂—CH₂CH₂—O—CH₂—CH₃—. It is preferably derived from polyethylene glycol. A general description is —(CH₂)₃—O)_{b}—H/CH₃, wherein a is a number from 1 to 6 and b is a number from 2 to 10.

C₂-C₁₈alkyl interrupted by at least one NR₆ group may be generally described as —((CH₂)ₐ—NR₅)_{b}—H/CH₃, wherein a, b and R₅ are as defined above.

C₃-C₁₂cycloalkyl is typically, cyclopropyl, cyclopentyl, methylcyclopentyl, dimethylcyclopentyl, cyclohexyl, methylcyclohexyl or trimethylcyclohexyl.

C₆-C₁₀ aryl is for example phenyl or naphthyl, but also comprised are C₁-C₄alkyl substituted: phenyl, C₁-C₄alkoxy substituted phenyl, hydroxy, halogen or nit substituted phenyl. Examples for alkyl substituted phenyl are ethylbenzene, toluene, xylene and its isomers, mesitylene or isopropylbenzene. Halogen substituted phenyl is for example dichlorobenzene or bromotoluene.

Alkoxy substituents are typically methoxy, ethoxy, propoxy or butoxy and their corresponding isomers.

C₇-C₈phenylalkyl is benzyl, phenylethyl or phenylpropyl.

C₅-C₁₀heteroaryl is for example pyrrol, pyrazol, imidazol, 2, 4, dimethylpyrrol, 1-methylpyrrol, thiophene, furane, furfural, indol, cumarone, oxazol, thiazol, isoxazol, isothiazol, triazol, pyridine, α-picoline, pyridazine, pyrazine or pyrimidine.

If R is a monovalent radical of a carboxylic add, it is, for example, an acetyl, propionyl, butyryl, valeroyl, caproyl, stearoyl, lauroyl, acryloyl, methacryloyl, benzoyl, cinnamoyl or β-(3,5-di-tert-butyl-4-hydroxyphenyl)propionyl radical.

C₁-C₁₈alkanoyl is for example, formyl, propionyl, butyryl, octanoyl, dodecanoyl but preferably acetyl and C₃-C₅alkenoyl is in particular acryloyl. in general the polymerization processes using nitroxylethers a1) or nitroxyl radicals together with a free radical initiator a2) are preferred. In particular polymerization process a1) is very suitable.

Particularly suitable nitroxylethers and nitroxyl radicals are those of formulae

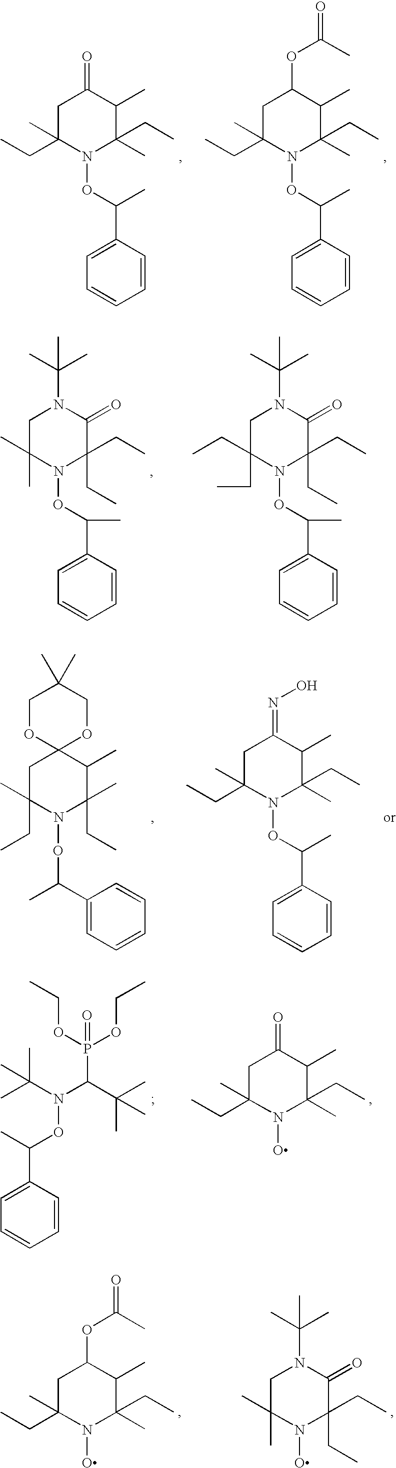

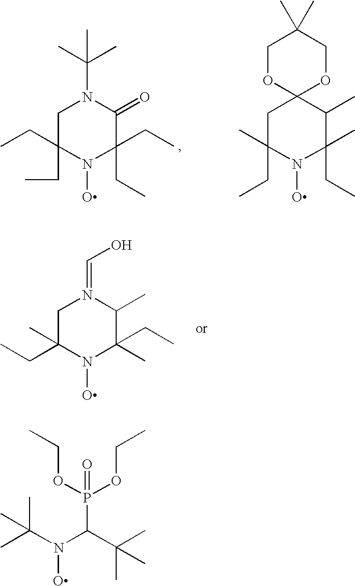

The free radical initiator of component a2) is preferably a bis-azo compound, a peroxide, perester or a hydroperoxide.

Specific preferred radical sources are 2,2′-azobisisobutyronitrile, 2,2′-azobis(2-methyl-butyronitrile), 2,2′-azobis(2,4-dimethylvaleronitrile), 2,2′-azobis(4-methoxy-2,4-dimethylvale-ronitrile, 1,1′-azobis(1-cyclohexanecarbonitrile), 2,2′-azobis(isobutyramide)dihydrate, 2-phenylazo-2,4-dimethyl-4-methoxyvaleronitrue, dimethyl-2,2′-azbisisobutyrate, 2-(carbamoylazo)isobutyronitrile, 2,2′-azobis(2,4,4-timethylpentane), 2,2′-azobis(2-methylpropane), 2,2-azobis(N,N′-dimethylenelsobutyramidine), free base or hydrochloride, 2,2′-azobis(2-amidinopropane), free base or hydrochloride, 2,2′-azobis{2-methyl-N-[1,1-bis(hydroxymethyl)ethyl]propionamide} or 2,2′-azobis{2-methyl-N-[1,1-bis(hydroxymethyl)-2-hydroxyethyl]propionamide; acetyl cyclohexane sulphonyl peroxide, diisopropyl peroxy dicarbonate, t-amyl pemeodecanoate, t-butyl pemeodecanoate, t-butyl perpivalate, t-amylperpivalate, bis(2,4-dichlorobenzoyl)peroxide, diisononanoyl peroxide, didecanoyl peroxide, dioctanoyl peroxide, dilauroyl peroxide, bis(2-methylbenzoyl)peroxide, disuccinic acid peroxide, diacetyl peroxide, dibenzoyl peroxide, t-butyl per 2-ethylhexanoate, bis-(4-chlorobenzoyl)-peroxide, t-butyl perisobutyrate, t-butyl permaleinate, 1,1-bis(t-butylperoxy)3,5,5-trimethylcyclohexane, 1,1-bis(t-butylperoxy)cyclohexane, t-butyl peroxy isopropyl carbonate, t-butyl perisononaoate, 2,5-dimethylhexane 2,5-dibenzoate, t-butyl peracetate, t-amyl perbenzoate, t-butyl perbenzoate, 2,2-bis (t-butylperoxy) butane, 2,2 bis(t-butylperoxy)propane, dicumyl peroxide, 2,5-dimethylhexane-2,5-di-t-butylperoxide, 3-t-butylperoxy 3-phenylphthalide, di-t-amyl peroxide, α,α′-bis(t-butylperoxy isopropyl)benzene, 3,5-bis(t-butylperoxy)3,5-dimethyl 1,2-dioxolane, di-t-butyl peroxide, 2,5-dimethylhexyne-2,5-di-t-butylperoxide, 3,3,6,6,9,9-hexamethyl 1,2,4,5-tetraoxa cyclononane, p-menthane hydroperoxide, pinane hydroperoxide, diisopropylbenzene mono-α-hydroperoxide, cumene hydroperoxide or t-butyl hydroperoxide.

A suitable component a3) contains a compound of formula (III), 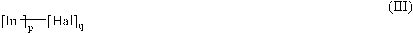
with a radically transferable atom or group .Hal as is described in WO 96/30421 and WO 98/01480. A preferred radically transferable atom or group .Hal is .Cl or .Br, which is cleaved as a radical from the initiator molecule.

Preferably [In] represents the polymerization initiator fragment of a polymerization initiator of formula (III), 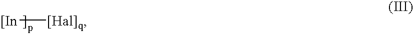
capable of initiating polymerization of monomers or oligomers which polymerization initiator is selected from the group consisting of C₁-C₈-alkyl halides, C₈-C₁₅-aralkylhalides, C₂-C₈α-haloalkyl esters, arene sulfonyl chlorides, haloalkane-nitriles, α-haloacrylates and halolactones, and

p and q represent one.

The polymerization process in the presence of a compound of formula (III) is known as ATRP (Atom Transfer Radical Polymerization) and WO 96/30421 discloses a controlled or “living” polymerization process of ethylenically unsaturated monomers such as styrene or (meth)acrylates by employing the ATRP method. According to this method initiators are employed which generate a radical atom such as .Cl, in the presence of a redox system of transition metals of different oxidation states, e.g. Cu(I) and Cu(II), providing “living” or controlled radical polymerization.

Specific initiators are selected from the group consisting of α,α′-dichloro- or α,α′-dibromoxylene, p-toluenesulfonylchloride (PTS), hexakis-(α-chloro- or α-bromomethyl)-benzene, 2-chloro- or 2-bromopropionic acid, 2-chloro- or 2-bromolsobutyric acid, 1-phenethyl chloride or bromide, methyl or ethyl 2-chloro- or 2-bromopropionate, ethyl-2-bromo- or ethyl-2-chloroisobutyrate, chloro- or bromoacetonitrile, 2-chloro- or 2-bromopropionitrile, α-bromo-benz-acetonitrile and α-bromo-γ-butyrolactone (=2-bromo-dihydro-2(3H)furanone).

The transition metal in the oxidizable transition metal complex catalyst salt used in the process of the invention is present as an oxidizable complex ion in the lower oxidation state of a redox system. Preferred examples of such redox systems are selected from the group consisting of Group V(B), VI(B), VII(B), VIII, IB and IIB elements, such as Cu⁺/Cu²⁺, Cu⁰/Cu⁺, Fe⁰/Fe²⁺, Fe²⁺/Fe³⁺, Ru²⁺/Ru³⁺, Ru³⁺/Ru⁴⁺, Os²⁺/Os³⁺, Vⁿ⁺/V⁽ⁿ⁺¹⁾⁺, Cr²⁺/Cr³⁺, Co⁺/Co²⁺, Co²⁺/Co³⁺, Ni⁰/Ni⁺, Ni⁺/Ni²⁺, Ni²⁺/Ni³⁺, Mn⁰/Mn²⁺, Mn²⁺/Mn³⁺, Mn³⁺/Mn⁴⁺ or Zn⁺/Zn²⁺.

The ionic charges are counterbalanced by anionic ligands commonly known in complex chemistry of transition metals, such hydride ions (H⁻) or anions derived from inorganic or organic acids, examples being halides, e.g. F⁻, Cl⁻, Br⁻ or I⁻, fluoro complexes of the type BF₄⁻; PF₆⁻, SbF₆⁻ or AsF₆⁻, anions of oxygen acids, alcoholates or acetylides or anions of cyclopentadiene.

Anions of oxygen acids are, for example, sulfate, phosphate, perchlorate, perbromate, penodate, antimonate, arsenate, nitrate, carbonate, the anion of a C₁-C₈carboxylic acid, such as formate, acetate, propionate, butyrate, benzoate, phenylacetate, mono-, di- or trichloro- or -fluoroacetate, sulfonates, for example methylsulfonate, ethylsulfonate, propylsulfonate, butylsulfonate, trifluoromethylsulfonate (triflate), unsubstituted or C₁.C₄alkyl-, C₁-C₄alkoxy- or halo-, especially fluoro-, chloro- or bromo-substituted phenylsulfonate or benzylsulfonate, for example tosylate, mesylate, brosylate, p-methoxy- or p-ethoxyphenylsulfonate, pentafluorophenylsulfonate or 2,4,6-triisopropylsulfonate, phosphonates, for example methylphosphonate, ethylphosphonate, propylphosphonate, butylphosphonate, phenylphosphonate, p-methylphenylphosphonate or benzylphosphonate, carboxylates derived from a C₁-C₈carboxylic acid, for example formate, acetate, propionate, butyrate, benzoate, phenylacetate, mono-, di- or trichloro- or -fluoroacetate, and also C₁-C₁₂-alcoholates, such as straight chain or branched C₁-C₁₂alcoholates, e.g. methanolate or ethanolate.

Anionic ligands and neutral may also be present up to the preferred coordination number of the complex cation, especially four, five or six. Additional negative charges are counterbalanced by cations, especially monovalent cations such as Na⁺, K⁺, NH₄⁺ or (C₁-C₄ alkyl)₄N⁺.

Suitable neutral ligands are inorganic or organic neutral ligands commonly known in complex chemistry of transition metals. They coordinate to the metal ion through a σ-, π-, μ-, η-type bonding or any combinations thereof up to the preferred coordination number of the complex cation. Suitable inorganic ligands are selected from the group consisting of aquo (H₂O), amino, nitrogen, carbon monoxide and nitrosyl. Suitable organic ligands are selected from the group consisting of phosphines, e.g. (C₆H₅)₃P, (i-C₃H₇)₃P, (C₅H₉)₃P or (C₅H₁₁)₃P, di-, tri-, tetra- and hydroxyamines, such as ethylenediamine, ethylenediaminetetraacetate (EDTA), N,N-Dimethyl-N′,N′-bis(2-dimethylaminoethyl)ethylenediamine (Me₆TREN), catechol, N,N′-dimethyl-1,2benzenediamine, 2-methylamino)phenol, 3-(methylamino)-2-butanol or N,N′-bis(1,1-dimethylethyl)-1,2-ethanediamine, N,N,N′,N″,N″-pentamethyldiethyltriamine (PMD-ETA), C₁-C₈-glycols or glycerides, e.g. ethylene or propylene glycol or derivatives thereof, e.g. di-, tri- or tetraglyme, and monodentate or bidentate heterocyclic e⁻ donor ligands.

Heterocyclic e⁻ donor ligands are derived, for example, from unsubstituted or substituted heteroarenes from the group consisting of furan, thiophene, pyrrole, pyridine, bis-pyridine, picolylimine, g-pyran, g-thiopyran, phenanthroline, pyrimidine, bis-pyrimidine, pyrazine; indole, coumarone, thioniaphthene; carbazole, dibenzofuran, dibenzothiophene, pyrazole, imidazole, benzimidazole, oxazole, thiazole, bis-thiazole, isoxazole, isothiazole, quinoline, bis-quinoline, isoquinoline, bis-isoquinoline, acridine, chromene, phenazine, phenoxazine, phenothiazine, triazine, thianthrene, purine, bis-imidazole and bis-oxazole.

The oxidizable transition metal complex catalyst can be formed in a separate preliminary reaction step from its ligands or is preferably formed in-situ from its transition metal salt, e.g. Cu(I)Cl, which is then converted to the complex compound by addition of compounds corresponding to the ligands present in the complex catalyst, e.g. by addition of ethylenediamine, EDTA, Me₈TREN or PMDETA.

Preferred is a composition, wherein in the step a3) the oxidizable transition metal in the transition metal complex salt is present as a transition metal complex ion in the lower oxidation state of a redox system.

More preferred is a composition, wherein the transition metal complex ion is a Cu(I) complex ion in the Cu(I)/Cu(II) system.

Routs a3) is carried out when comb copolymers are prepared. The preparation of comb copolymers by the ATRP method is for example described in WO 01/51534.

The elimination of the transfer group —Y. e. g. halogen, wit a polymerizable chain terminating group —X is advantageously performed in such a way that the polymerisate is dissolved in a solvent and the monomeric compound corresponding to —X is added in the presence of a non-nucleophilic base, such as diazabicycloundecene (DBU) or similar bases, at elevated temperatures. The reaction, which is a conventional esterification reaction, takes place under conditions of a regular esterification reaction within a temperature range, for example from room temperature to 100° C.

Preferably the nitroxylether of step a1) or the nitroxyl radical of step a2) is present in an amount of from 0.001 mol-% to 20 mol-%, more preferably of from 0.002 mol-% to 10 mol-% and most preferably of from 0.005 mol-% to 5 mol-% based on the monomer or monomer mixture.

Preferably the free radical initiator is present in an amount of 0.001 mol-% to 20 mol-%; based on the monomer or monomer miture.

The molar ratio of free radical initiator to stable free nitroxyl radical is preferably from 20:1 to 1:2, more preferably from 10:1 to 1:2.

Scission of the O—X bond of the nitroxylether may be effected by ultrasonic treatment, radiation with actinic light or heating.

The scission of the O—X bond is preferably effected by heating and takes place at a temperature of between 50° C. and 180° C., more preferably from 90° C. to 150° C.

The initiator of formula (III), 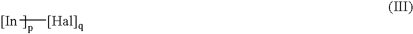
and the oxidizable transition metal are for example present in an amount of 1:10 to 1:100, relative to the monomer. The total amount of oxidizable transition metal to initiator of formula (III) is for e)ample from 0.05:1 to 2:1, in particular from 0.2:1 to 0.5:1.

The polymerization reaction is carried out with preference under atmospheric pressure. In the block or comb copolymer the nonionic polymer block B is composed of non-ionic repeating units of ethylenically unsaturated monomers suitable for the method of controlled or living polymerisation. These monomers are characterised by the presence of at least one group >C═C< Representative monomers are selected from the group consisting of styrenes, acrylic and C₁-₄alkylacrylic acid-C₁-C₂₄alkyl esters, acrylic and C₁-C₄alkylacrylic acid-C₆-C₁₁aryl-C₁-C₄alkyl esters, acrylic and C₁-C₄alkylacrylic acid-C₆-C₁₁aryloxy-C₁-C₄alkyl esters, acrylic and C₁-C₄alkylacrylic acid-hydroxy-C₂-C₈alkyl esters, acrylic and C₁-C₄alkylacrylic acid-polyhydroxy-C₃-C₆alkyl esters, acrylic and C₁-C₄alkylacrylic acid-(C₁-C₄alkyl)₃silyl-oxy-C₂-C₄alkyl esters; acrylic and C₁-C₄alkylacrylic acid-(C₁-C₄alkyl)₃silyl-C₁-C₄alkyl esters, acrylic and C₁-C₄alkylacrylic acid-heterocyclic-C₂-C₄alkyl esters; acrylic and C₁-C₄alkylacrylic add esters having poly-C₂-C₄alkyleneglycolester groups, wherein the ester groups may be substituted with C₁-C₂₄alkoxy groups, acrylic and methacrylic acid amides, acrylic and C₁-C₄alkylacrylic -acid-(C₁-C₄alkyl)₁₋₂amide, acrylonitrile, esters of maleic acid or fumaric acid, maleinimide and N-substituted maleinimides.

In a preferred embodiment of the invention the nonionic polymer block B is essentially composed of repeating units of ethylenically unsaturated monomers selected from the group consisting of styrenes, acrylic and methacrylic acid-C₁-C₂₄alkyl esters, acrylic and meth-acrylic acid-hydroxy-C₂-C₆alkyl esters, acrylic and methacrylic acid-dihydroxy-C₃-C₄alkyl esters and acrylic and methacrylic acid esters having poly-C₄-C₄alkyleneglycolester groups, wherein the ester groups may be substituted with C₁-C₂₄alkoxy groups.

Suitable styrenes may be substituted at the phenyl group by one to three additional substituants selected from the group consisting of hydroxy, C₁-C₄alkoxy, e.g. methoxy or ethoxy, halogen, e.g. chloro, and C₁-C₄alkyl, e.g. methyl or methyl.

Suitable acrylic acid or methacrylic add-C₁-C₂₄alkyl esters are acrylic acid or methacrylic acid esters esterified by methyl, ethyl, n-butyl, isobutyl, tert-butyl, neopentyl, 2-ethylhexyl, isobornyl, isodecyl, n-dodecyl, n-tetradecyl, n-hexadecyl or n-octadecyl.

Representative acrylic and C₁-C₄alkylacrylic acid-C₈-C₁₁aryl-C₁-C₄alkyl esters are acrylic acid or methacrylic acid esters esterified by benzyl, 2-phenylethyl, 1- or 2-naphthylmethyl or 2-(1- or 2-naphthyl)-ethyl. The phenyl or naphthyl groups may be additionally substituted with one to three additional substituents selected from the group consisting of hydroxy, C₁-C₄alkoxy, e.g. methoxy or ethoxy, halogen, e.g. chloro, and C₁-C₄alkyl, e.g. methyl or methyl.

Representative acrylic and C₁-C₄alkylacrylic acid C₈-C₁₁aryloxy-C₁-C₄alkyl esters are acrylic acid or methacrylic acid esters esterified by phenoxyethyl or benzyloxyethyl.

Representative acrylic acid and C₁-C₄alkylacrylic acid-hydroxy-C₂-C₄alkyl esters are acrylic acid- or methacrylic acid-2-hydroxyethylesters (HEA, HEMA) or acrylic acid- or methacrylic acid-2-hydroxypropylester (HPA, HPMA).

Representative acrylic and C₁-C₄alkylacrylic acid-polyhydroxy-C₃-C₆alkyl esters are acrylic acid- or methacrylic acid esterified by ethylene glycol or glycerol.

Representative acrylic acid- and C₁-C₄alkylacrylic acid-silyloxy-C₂-C₄alkyl ester are acrylic acid- or methacrylic acid-2-trimethylsilyloxyethylesters (TMS-HEA, TMS-HEMA).

Representative acrylic acid- or C₁-C₄alkylacrylic acid-(C₁-C₄alkyl)₃silyl-C₂-C₄alkyl esters are acrylic acid- or methacrylic acid-2-trimethylsilylethylesters or acrylic acid- or methacrylic acid-3-trimethylsilyl-n-propylesters.

Representative acrylic and C₁-C₄alkylacrylic acid esters having poly-C₂-C₄alkyleneglycolester groups, wherein the ester groups may be substituted with C₁-C₂₄alkoxy groups, are illustrated by the formula given below:

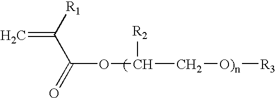

wherein

n represents a numeral from one to 100;

R₁ and R₂ independently of one another represent hydrogen or methyl; and

R₃ represents C₁-C₂₄alkyl, e.g. methyl, ethyl, n- or isopropyl, n-, iso-, or tert-butyl, n- or neo-pentyl, n-dodecyl, n-tetradecyl, n-hexadecyl, n-octadecyl, or represents aryl-C₁-C₂₄alkyl, e.g. benzyl or phenyl-n-nonyl, as well as C₁-C₂₄alkylaryl or C₁-C₂₄alkylaryl-C₁-C₂₄alkyl.

Representative acrylic acid- and C₁-C₄alkylacrylic acid-heterocyclyl-C₂-C₄alkyl esters are acrylic acid- or methacrylic acid-2-(N-morpholinyl, 2-pyridyl, 1-imidazolyl, 2-oxo-1-pyrrolidinyl, 4-methylpiperidin-1-yl or 2oxoimidazolidin-1-yl)-ethyl esters.

Representative C₁-C₄alkylacrylic acid esters having poly-C₂-C₄alkyleneglycolester groups, wherein the ester groups may be substituted with C₁-C₂₄alkoxy groups are acrylic acid- or methacrylic acid esters of ethoxylated decanol, ethoxylated lauryl alcohol or ethoxylated stearyl alcohol, wherein the degree of ethoxylation, as expressed by the index n in the formula above, is typically in the range from 5 to 30.

Representative acrylic and C₁-C₄alkylacrylic acid-C₁-C₄allyl)₁₋₂amide are acrylic acid- or methacrylic acid N-methyl, N,N-dimethyl, N-ethyl or N,N-diethyl amide.

Representative esters of maleic acid or fumaric acid are the C₁-C₂₄alkyl esters, e.g. the methyl, ethyl, n-butyl, isobutyl, tert-butyl, neopentyl, 2-ethylhexyl, isobornyl, isodecyl, n-dodecyl, n-tetradecyl, n-hexadecyl or n-octadecyl esters, the C₈-C₁₁aryl, e.g. phenyl or naphthyl, esters or the C₆-C₁₁aryl-C₁-C₄alkyl esters, e. g. benzyl or 2-phenethyl esters. The phenyl or naphthyl groups may be additionally substituted with one to three additional substituents selected from the group consisting of hydroxy, C₁-C₄alkoxy, e.g. methoxy or ethoxy, halogen, e.g. chloro, and C₁-C₄alkyl, e.g. methyl or methyl.

Representative N-substituted maleinimides are the N—C₁-C₄alkyl, e.g. N-methyl or N-ethyl, or N-aryl, e.g. N-phenyl substituted maleinimides.

In the comb or block copolymer the polymer block A additionally contains repeating units of ethylenically unsaturated monomers substituted with cationic groups. A suitable cationic polymer block A is essentially composed of repeating units of ethylenically unsaturated monomers represented by the cationic part of a salt formed by quaternisation of an amino monomer selected from the group consisting of amino substituted styrene, (C₁-C₄alkyl)₁₋₂amino substituted styrene, N-mono-(C₁-C₄alkyl)₁₋₂amino-C₂-C₄alkyl(meth)acrylamide and N,N-di-(C₁-C₄alkyl)₁₋₂amino-C₂-C₄alkyl(meth)acrylamide, vinylpyridine or C₁-C₄alkyl substituted vinylpyridine, vinylimidazole and C₁-C₄alkyl substituted vinylimidazole and a compound of the formula
CH₂═C(—R¹)—C(═O)—Re (V),
wherein
R¹ represents hydrogen or C₁-C₄alkyl; and
R² represents amino substituted C₂-C₁₈alkoxy selected from the group consisting of amino-C₂-C₁₈alkoxy, C₁-C₄alkylamino-C₂-C₁₈alkoxy, di-C₁-C₄alkylamino-C₂-C₁₈alkoxy, hydroxy-C₂-C₄alkylamino-C₂-C₁₈alkoxy and C₁-C₄alkyl-(hydroxy-C₂-C₄alkyl)-amino-C₂-C₁₈alkoxy.

In a particularly preferred embodiment of the invention the repeating unit of an ethylenically unsaturated monomer substituted with an cationic group is represented by the cationic part of a salt formed from a compound of the formula (V), wherein

R¹ represents hydrogen or methyl; and

R² represents amino substituted C₂-C₁₀alkoxy selected from the group consisting of amino-C₂-C₄alkoxy, C₁-C₄alkylamino-C₂C₄alkoxy, di-C₁-C₄alkylamino-C₂-C₄alkoxy, hydroxy-C₂C₄-alkylamino-C₂-C₁₈alkoxy and C₁-C₄alkyl-(hydroxy-C₂-C₄alkyl)amino-C₂-C₄alkoxy.

In an alternative embodiment the repeating unit of an ethylenically unsaturated monomer is the acid addition salt or the salt formed by quaternisation of an amino monomer selected from the group consisting of amino substituted styrene, (C₁-C₄alkyl)₁₋₂amino substituted styrene N-mono-(C₁-C₄alkyl)₁₋₂aminoC₂-C₄alkyl(meth)acrylamide and N,N-di-(C₁-C₄alkyl)₁₋₂amino-C₂-C₄alkyl(meth)acrylamide, vinylpyridine or C₁-C₄alkyl substituted vinylpyridine, vinylimidazole and C₁-C₄alkyl substituted vinylimidazole.

Representative styrenes are substituted at the phenyl group with one or two amino groups or one or two (C₁-C₄alkyl)₁₋₂ amino groups, particularly one amino group in 4-position. Additional substituents are selected from the group consisting of hydroxy, C₁-C₄alkoxy, e.g. methoxy or ethoxy, halogen, e.g. chloro, or C₁-C₄alkyl, e.g. methyl or ethyl.

Representative N-mono-(C₁-C₄alkyl)₁₋₂amino-C₂-C₄alkyl(meth)acrylamide, and N,N-di-(C₁-C₄alkyl)₁₋₂amino-C₄alkyl(meth)acrylamide are 2N-tert-butylamino- or 2-N,N-dimethyl-aminoethylacrylamide or 2-N-tertbutylamino- or 2-N,N-dimethylaminopropylmethacrylamide. In another preferred embodiment of the invention the repeating unit of an ethylenically unsaturated monomer substituted with an ionic group present in one of the polymer blocks A and B is the acid addition salt or the salt formed by quaternisation of an amino monomer selected from the group consisting of amino substituted styrene, (C₁-C₄alkyl)₁₋₂amino substituted styrene, and N,N-di-(C₁-C₄alkyl)₂amino-C₂-C₄alkyl(meth)acrylamide.

For example the cationic part of a salt according to formula (V) is represented by an ester group of the formula (C) 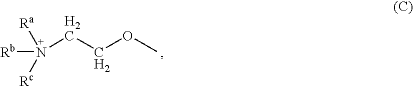
wherein
one of R^{a}, R^{b} and R^{c} represents 2-hydroxyethyl and the other ones represent hydrogen, methyl or ethyl; or

R^{a}, R^{b} and R^{c} independently of one another represent hydrogen or a substituent selected from the group consisting of C₁-C₄alkyl, aryl-C₁-C₄alkyl and (C₁-C₄alkyl)₁₋₃aryl.

In an especially preferred embodiment of the invention the repeating unit of an ethylenically unsaturated monomer substituted with an ionic group is represented by the cationic part of an acid addition salt or the salt formed by quaternisation of 4-aminostyrene, 4-dimethylaminostyrene and an aminoalkyl (meth)acrylates selected from the group consisting of 2-dimethylaminoethyl acrylate (DMAEA), 2-dimethylaminoethyl methacrylate (DMAEMA), 2-diethylaminoethyl acrylate (DEAEA), 2-diethylaminoethyl methacrylate (DEAEMA), 2-t-butylamino-ethyl acrylate (tBAEA), 2-t-butylaminoethyl methacrylate (t-BAEMA) and 3-dimethylamino-propylmethacrylamide, 4-vinylpyridine, 2-vinylpyridine or 1-vinylimidazole.

For example the number of repeating units of the nonionic block B is from 4-1000.

For instance the number of repeating units of the cationic block A is from 1-100.

In a specific embodiment of the invention the non-ionic block B is composed of butylacrylate (BA) and the ionic block A is composed of 2-dimethylaminoethyl acrylate (DMAEA) or 2-dimethylaminoethyl methacrylate (DMAEMA). In order to get a maximized exploitation the length of the total blocks is for example more than 30 units. However in some cases also lower length may provide a sufficient intercalation and exfoliation.

Typical blockpolymers are for example Poly (BA)₁₆-block-(DMAEA)_{4,5} or Poly (BA)₆₈-block-DMAEA)₁₉.

The counterion present in the salt forming component free amino group or a primary, secondary or tertiary amino group may be the anion of a carboxylic acid, phosphonic acid, sulfonic acid, mineralic acid or complex acid. Examples of the anions of mineral acids are F⁻, Cl⁻, Br⁻ or I⁻. Examples for the anions of complex acids are ClO₄⁻, SbF₈⁻ or PtF₆⁻.

In a specific embodiment of the invention the counterion of the salt forming component is selected from the group consisting of mono-, bi- or tricyclic sulphonic, carboxylic or phosphonic acids and aliphatic sulphonic, carboxylic or phosphonic acids substituted with mono-, bi- or tricyclic groups alkyl halides substituted with mono-, bi- or tricyclic groups, and C₁-C₄alkyl esters of mono-, bi- or tricyclic sulphonic acids.

The mono-, bi-, or tricyclic groups present in the sulphonic, carboxylic and phosphonic acids or the mono-, bi-, or tricyclic substituants of the aliphatic sulphonic, carboxylic or phosphonic acids and alkyl halides are selected from the group consisting of saturated or unsaturated mono-, bi-, or tricyclosliphatic, heteromonocycloaliphatic or heterobicycloaliphatic, carbomonocyclic or carbobicyclic aromatic, partially saturated carbobicyclic aromatic, heteromonocyclic or heterobicyclic aromatic and partially saturated heterobicyclic aromatic groups.

Representative salt forming components which are selected from the group consisting of mono-, bi-, or tricyclic sulphonic, carboxylic and phosphonic acids or represent salt forming components which are selected from the group of aliphatic sulphonic, carboxylic or phosphonic acids substituted with monocyclic, bicyclic or tricyclic groups are illustrated by the list given below:

A preferred group of substituted mono-, bi-, or tricyclic sulphonic, carboxylic and phosphonic acids is represented by the general formula:

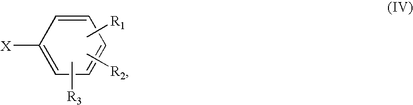

wherein

X represents carboxy, sulpho or P(═O)(OH)₂; and

R₁, R₂ or R₃ independently of one another represent hydrogen or a substituent selected from the group consisting of functional groups or derivatised functional groups selected from the group consisting of amino, C₁-C₄alkylamino, C₁-C₄-dialkylamino, hydroxy, oxo, thio, —NO₂, carboxy, carbamoyl, sulpho, sulphamoyl, ammonia, amidino, cyano, formylamino, formamido and halogen; or

R₁, R₂ or R₃ independently of one another represent saturated or unsaturated aliphatic, cycloaliphatic or heterocycloaliphatic groups, carbocyclic or heterocyclic aryl groups, condensed carbocyclic, heterocyclic or carbocyclic-heterocyclic groups, which may additionally be combined with one of these groups or which may additionally be substituted with one of the functional groups or derivatised functional groups mentioned above.

The substituent groups may additionally be interrupted with one or more bivalent groups selected from the group consisting of —O—, —S—, —C(═O)—O—, —O—C(═O)—, —C(═O)—N(C₁-C₄alkyl)-, —N(C₁-C₄alkyl)-C(═O)—, —S(═O)—, —S(═O)₂—, —S(═O)—O—, —S(═O)₂—O—, —O—S(═O)—, —O—S(═O)₂—, —S(═O)—N(C₁-C₄allyl)-, —S(═O)₂—N(C₁-C₄alkyl)-, —(C₁-C₄alkyl)N—S(═O)—, —(C₁-C₄alkyl)N—S(═O)₂—, —P(═O)—, —P(═O)—O—, —O—P(═O)— and —O—P(═O)—O—.

Two substituents from the group R₁ and R₂ may also represent bhalent, bridge-types C₂-C₀alkylen-, C₄-C₆alkyldiyliden- or C₄-C₈alkenyldiyliden groups which are connected with one of the above-mentioned cyclic or bicyclic groups.

Specific salt forming components, which are selected from the group consisting of mono- or bicyclic sulphonic acids, are illustrated by their structural formulae given below.

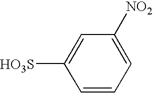

3-nitro-benzene sulphonic acid

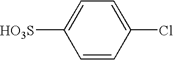

4-chlorobenzene sulphonic acid

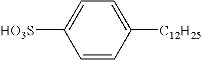

4-dodecylbenzone sulphonic acid

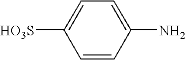

sulphanilic acid

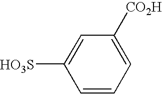

3-sulphobenzoic acid

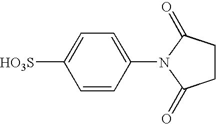

4-succinimidobenzene sulphonic acid

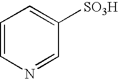

pyridine-3-sulphonic acid

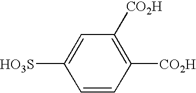

4-sulphophtalic acid

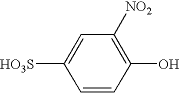

4-hydroxy-3-nitrobenzene sulphonic acid

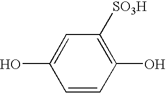

2,5-dihydroxybenzene sulphonic acid

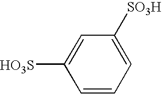

benzene-1,3-disulphonic acid

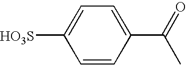

4-acetylsulphonic acid

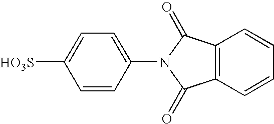

4-phthalimidobenzene sulphonic acid

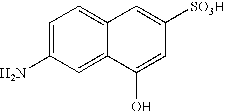

7-amino-1-naphtol-3-sulphonic acid

Further specific salt forming components, which are selected from the group consisting of mono- or bicyclic sulphonic acids are illustrated by their structural formulae given below:

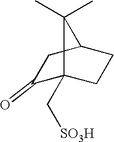

(+−)camphor-10-sulphonic acid

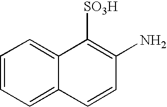

2-naphthylamine-1-sulphonic acid acid isomers

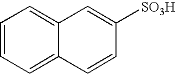

naphthalene-2-sulphonic acid

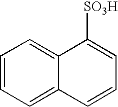

naphthalene-1-sulphonic acid

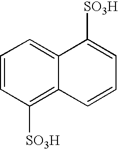

naphthalene1,5-disulphonic acid and isomers

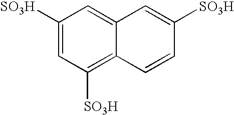

naphthalene-trisulphonic acid, isomer mixture e.g.
naphthalene 1,3,6-trisulphonic acid

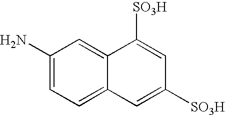

2-naphthylamine-6,8-disulphonic acid and isomers

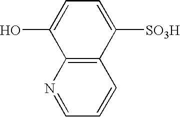

8-hydroxyquinoline sulphonic acid

Specific salt forming components, which are selected from the group consisting of mono- or bicyclic carboxylic acids are illustrated by their structural formulae given below:

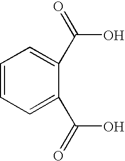

phthalic acid

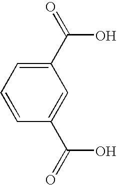

isophthalic acid

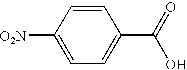

4-nitrobenzoic acid and isomers

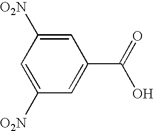

3,5-dinitrobenzoic acid and isomers

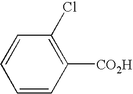

2-chlorobenzoic acid and isomers

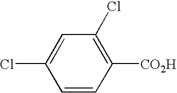

2,4-dichlorobenzoic acid and isomers

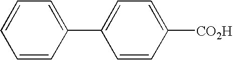

4-phenylbenzoic acid

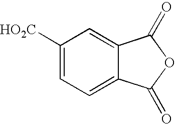

trimellitic acid anhydride

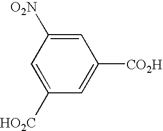

5-nitro-isophthalic acid

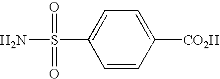

benzoic acid-4-sulphamide

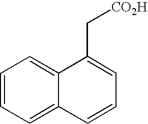

1-naphthylacetic acid

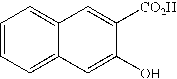

3-hydroxynaphthoic acid

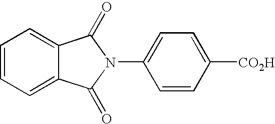

N-(4-carboxyphenyl)phthalimide

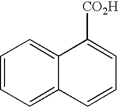

1-naphthoic acid

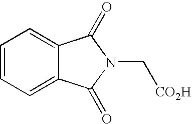

phthaloyl glycine

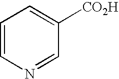

nicotinic acid

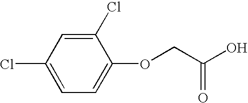

2,4-dichlorophenoxyacetic acid

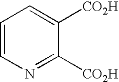

quinolinic acid

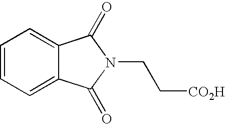

3-phthalimidoproplonic acid

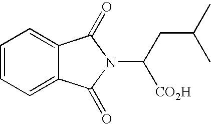

4-methyl-2-phthalimidovaleric acid

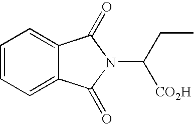

2-phthalimidobutyric acid

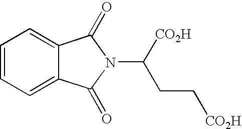

2-phthalimidoglutaric acid

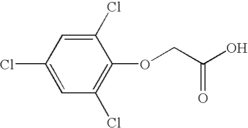

2,4,6-trichlorophenoxyacetic acid

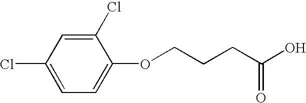

4(2,4-dichorophenoxy)-butyric acid

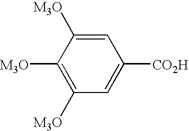

3,4,5-trimethoxybenzoic acid

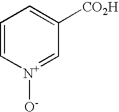

nicotinic acid N-oxide

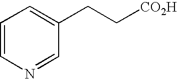

3-pyridinepropionic acid

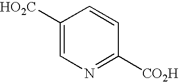

pyridine-2,5-dicarboxylic acid

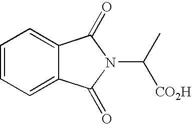

2-phthalimidopropionic acid

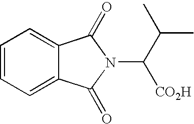

2-phthalimidoisovaleric acid

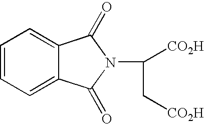

phthalimidosuccinic acid

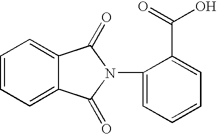

2-phthalimidobenzoic acid

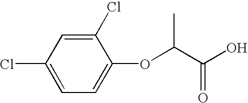

2(2,4-dichlorophenoxy)-propionic acid

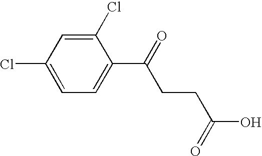

3(2,4-dichlorobenzoyl)-propionic acid

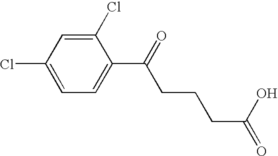

3(2,4-dichlorobenzoyl)-butyric acid

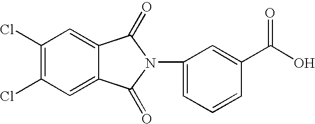

3(4,5-dichlorophthalimido)-benzoic acid

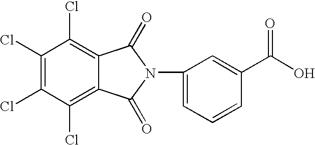

3-tetrachlorophthalimidobenzoic acid

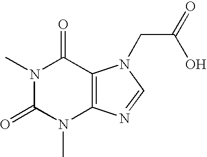

theophyline-7-acetic acid

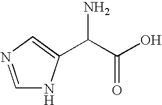

histidine

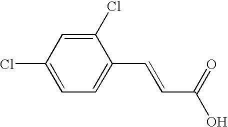

2,4-dichlorophenylacrylic acid

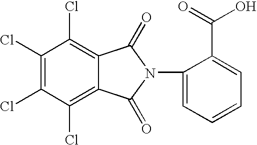

2-tetrachlorophthalimidobenzoic acid

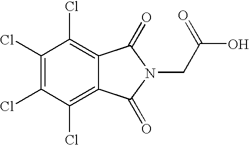

tetrachlorophthaloylglycine

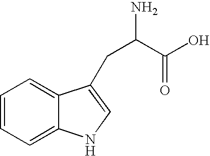

tryptophane

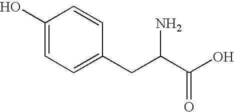

tyrosine

Further specific salt forming components, which are selected from the group consisting of mono- or bicyclic carboxylic acids and phosphonic acids are illustrated by their structural formulae given below:

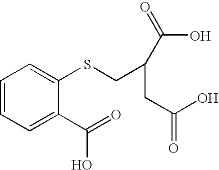

2(2-carboxyphenylthiomethyl)succinic acid

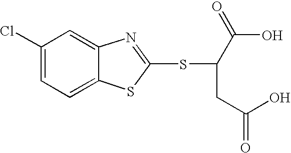

2(5-chlorobenzothiazol-2-ylthio)succinic acid

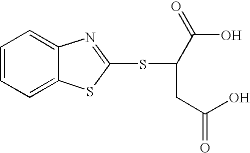

2-benzothiazol-2-ylthiosuccinic acid

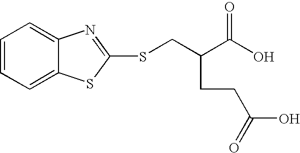

2-benzothiazol-2-ylthiomethylglutaric acid

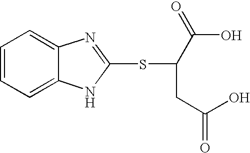

2-benzimidazol-2-ylthiosuccinic acid

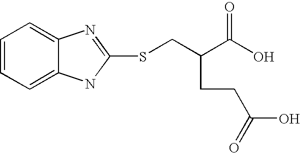

2-benzimidazol-2-ylthiosuccinic acid

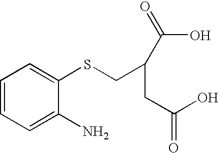

2(2-aminophenylthiomethyl)-succinic acid

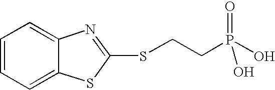

2-benzothiazol-2-ylthioethanephosphonic acid

Typically the block or comb copolymer is added to the natural or synthetic clay in an amount of from 1% to 1000% by weight, based on the weight of the clay, preferably of from 20% to 400% and more preferably from 50% to 400%.

Preferably the polydispersity of block A and B is between 1 and 2.

In particular the polydispersity of the blockoopolymer A-B is between 1 and 2.

A further aspect of the invention is a block or comb copolymer, clay nanocomposite dispersion obtainable by a process as described above.

The intercalated clay can, for example be isolated as a powder. The isolation process may be carried out, for example, by centrifugating the corresponding aqueous dispersion. Another possibility is, to completely evaporate water and solvents and subject the solid residue to a Soxhlet extraction with a suitable organic solvent, to remove excess polymer. Suitable organic solvents are, for example, esters, ethers or aromatic solvents. The purified solid material can easily be redispersed in water to result in a clay nanocompsite dispersion.

The nanocomposite dispersions are useful for example in, coatings, sealants, caulks, adhesives and as plastic additives to modify the physical properties of the final products.

Typically scratch resistance or water vapour permeation of coatings or polymer films are advantageously influenced by the addition of the instant nanocomposite dispersions.

It is typical for nanocompsite dispersions, that considerable less must be added for example to a coating as compared to conventional additives to achieve the same or even a better effect in many cases even transparency of the coating is retained.

Use of a block copolymer having one ammonium cationic block A, and at least one neutral block B or a comb copolymer having an ammonium ion containing cationic backbone A and neutral oligomeric polymeric chains B attached thereto, wherein the block copolymer and the comb copolymer is obtained by controlled free radical polymerization as described above for the preparation of nanocomposite dispersions of natural or synthetic clay.

The following examples illustrate the invention.

### EXAMPLE 1

A block-copolymer of n-butyl acrylate and dimethyl aminoethyl acrylate (DMAEA) was synthesized by ATRP: 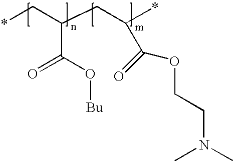
n=7.7, m=2.0; GPC: Mₙ=1710, M_{w}=2050, PDI=1.20; N-content: 1.62 wt. % (elemental analysis)

A) Preparation of the first block, poly-n-butylacrylate with terminal Br-groups:

1282 g (10.0 mol) n-butylacrylate (BASF, tech. quality), 1282 g acetone (Fluka purum), 28.45 9 (0.2 mol) CuBr and 2.23 g (0.01 mol) CuBr₂ are added to a 4500 ml round flask equipped with a mechanical stirrer. The air is removed from the flask by stirring and evacuating and rinsing with nitrogen three times. 34.7 9 (0.2 mol) PMDETA (N,N,N′,N″,N″-pentamethyldiethyltriamine: Fluka/purum) are added through the rubber sealing with a syringe and the mixture homogenized by stirring.

After addition of 167 g (1 mol) methyl-2-bromo-propionate (MBP, =initiator) with a syringe and heating up to 60° C. in the oil bath the exothermal polymerization reaction is started and is controlled by ice cooling to T=60-65° C. The mixture is polymerized for 7.5 h. The conversion (77%) is determined by ¹HNMR-analysis in CDCl₃ (08% after 75 Min.) After cooling to room temperature 300 g neutral aluminum oxide (ALOX for chromatography, Merck) are added. After stirring the mixture for 1 h, filtration and drying in the rotary evaporator at 80° C., additional drying with a vacuum pump the polymer (slightly yellow, dear liquid) is obtained.

Yield: 1192 g (98%). Elementary analysis:

| | C | H | Br |
|---|---|---|---|
| calc. | 60.47 | 8.71 | 6.66 |
| found | 61.24 | 8.78 | 5.28 |

Cu: <10 ppm (X-ray fluorescence); GPC (THF): Mₙ: 1150, M_{w}: 1370, PDI: 1.19. (92%).

B) Preparation of the block copolymer of n-butylacrylate and 2-dimethylaminoethyl acrylate:

200 g poly-n-butylacrylate (0.18 mol Br, Ex. 1A) and 5.16 g (0.036 mol) CuBr (Fluka, purum) are added to a 750 ml round flask equipped with a mechanical stirrer. The air is removed from the flask by stirring and evacuating and rinsing with nitrogen three times. The mixture is stirred and 51.5 g (0.36 mol) 2-dimethylaminoethyl acrylate (DMAEA, BASF, technical quality) are added through the rubber sealing with a syringe. The air is removed again from the flask by evacuating and rinsing with nitrogen three times. 6.24 g (0.036 mol) PMDETA (Fluka/purum) are added with a syringe, and the mixture is made homogeneous by stirring. After heating up to 90° C. in the oil bath the slightly exothermal polymerization reaction is started and the mixture is polymerized for 30 min. The conversion of DMAEA is quantitative, as determined by ¹H-NMR-analysis in CDCl₃. After cooling to room temperature 250 ml ethyl acetate and 110 g neutral aluminum oxide (Alox® for chromatography) are added and the mixture stirred for 1.5 h. The polymer is obtained after filtration and drying in the rotary evaporator at 80° C. with a vacuum pump. Yield: 155.6 g (62 %).

Elementary analysis:

| | C | H | N | Br |
|---|---|---|---|---|
| calc. | 59.98 | 8.72 | 1.95 | 4.20 |
| found | 61.17 | 9.01 | 1.62 | 3.62 |

GPC (THF): Mₙ: 1720, M_{w}: 2020, PDI: 1.18.

C) Protonation of the block copolymer with p-toluene sulfonic acid:

In a 500 ml round bottom flask with mechanical stirring, 145 g of the copolymer is dissolved in 60.8 g 1-methoxy-2-propanol (Dowanol PM) and a solution of 31.9 g p-toluene sulfonic acid monohydrate (Fluka purum), dissolved in 200 g hot Dowanol PM, is slowly added with good stirring during 1 h at room temperature. A clear, slightly yellow solution with 40 wt. % solid content of the cationic block copolymer is obtained.

D) Intercalation of sheet silicates (Nanofil EXM 588 from Süd Chemie, Germany; sheet silicate of Montmorillonite-type) with cationic block copolymer Poly(BA-b-DMAEA) described under C).

22.9 g of the above solution containing 9.15 9 of the cationic block copolymer A) is put into a 100 ml round bottom flask with mechanical stirring, 30 9 Dowanol PM and 5 9 water are added. 3.49 g Nanofil EXM 588 (Süd Chemie, Germany) is dispersed in this mixture, homogenized and stirred for 24 h at 60° C. It is then centrifuged (IEC Centra GP8 Centrifuge) with 2000 rpm (corresponding to ca. 850 g) during 1 h, the supernatend is decanted and the, solid residue at the bottom is washed with EtOH and again centrifuged for 1 h at 2000 rpm. After again decanting the supernatend, the procedure is repeated once more with a water/EtOH 1/1 (vol) mixture. The solid is dried in vacuum (0.1 mbar) at 50° C. for 24 h. Yield: 4.0 g.

Analysis:

TGA: The amount of adsorbed organic material (cationic block copolymer) is determined by thermogravimetric analysis (TGA): heating rate: 10° C./min, from room temperature to 600° C. The observed weight loss of 30% corresponds to a solid content of 70 wt. %.

GPC: A direct measurement of the sample is not possible because the polymer chains are tightly attached to the sheet silicate will not pass the GPC columns. Therefore, a sample (150 mg) of this solid is refluxed with 15 ml 0.2 M LiBr solution in THF during 17 h at 65° C., to cleave off the polymer from the sheet silicate. After filtration, the molar mass (Mₙ) and PDI is determined by GPC in THF (relative to PS-standards): Mₙ=1450, M_{w}=2050 and PDI=1.42, correspond well to the data of the block-copolymer used for intercalation.

Powder X-ray: The product is also subjected to a powder X-ray (λ=1.54 Angström), giving an interlayer distance of 1.96 nm. Compared with the native sheet silicate (d=1.24 nm) an increase of the interlayer distance of 0.72 nm is obseved, corresponding to approximately the size of the intercalated cationic block-copolymer. The reflex at the original sheet distance has completely disappeared.

E) intercalation of an artificial sheet silicate Optigel SH (Süd Chemie, Germany) with the cationic block copolymer Poly(BA₆₃-b-DMAEMA₁₉) with 68 BA and 19 DMAEMA units, synthesized as described under A and B and protonated as described under C.

770.3 g of a 30 wt. % solution of the cationic block copolymer Poly(BA₆₈-b-DMAEMA₁₉) in Dowanol PM (Fluka, puriss p.a.), 50% of the DMAEMA units neutralized with p-toluene sulfonic acid as described in C, are put into a 2.5 L round bottom flask with mechanical stirring. 1.4 Dowanol PM and 140 ml water are added. 120 g Optigel SH (Süd Chemie, Germany) is dispersed in this mixture, homogenized and stirred for 24 h at 60° C. The solvents are evaporated in a rotavap and the solid residue extracted in a 1 L Soxhlet extractor, first 12 h with 2 L ethyl acetate, then 4 h with 2 L ethanol and finally 14 h with 2 L ethanol/water 1:1 mixture. The gray solid is redispersed in EtOH, filtered and dried in vacuum (0.1 mbar) at 55° C. for 24 h. Yield: 255.5 g of a white powder is obtained.

Analysis:

TGA: The amount of adsorbed organic material (cationic block copolymer) is determined as before, giving 54 wt. % (=46 wt. % solid content).

GPC: (Sample preparation as before) Mₙ=10000, M_{w}=14300, PDI=1.43.

Powder X-ray: Complete exfoliation with interlayer distance d>3 nm.

### EXAMPLE 2

A) in analogy to Example 1, a longer block-copolymer of n-butyl acrylate and dimethyl aminoethyl acrylate (DMAEA) is synthesized.

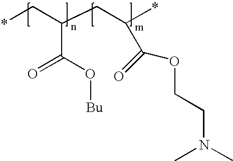

Analysis: n=27.6, m=8.7; Mn=6270, Mw=7710, PDI=1.23

100% of the amino groups are neutralized with p-toluene sulfonic acid monohydrate Dowanol PM to a dear, slightly yellow solution with 30.5 wt. % solid content of the cationic block copolymer.

E) intercalation of a sheet silicate with a longer cationic black copolymer Poly(BA-b-DMAEA) prepared as described under A)

300 g of above solution containing 91.5 g of the cationic block copolymer A) is put into a 1000 ml round bottom flask with mechanical stirring and 250 g Dowanol PM and 50 g water are added. 34.9 g Nanofil EXM 588 (Süd Chemie, Germany) is dispersed in this mixture with a high speed Ultraturax mixer, homogenized and stirred for 24 h at 60° C. It is then centrifuged (2000 rpm) during 1 h, the supernatend is decanted and the solid residue at the bottom dispersed in 300 ml ethyl acetate and again centrifuged for 1 h at 2000 rpm. After again decanting, the supernatend, the solid is redispersed in 300 ml EtOH with an Ultraturax and centrifuged again for 1 h. The gray solid is-redispersed in a water/EtOH 4/1 (vol) mixture and filtered. The solid is dried in vacuum (0.1 mbar) at 40° C. for 24 h. Yield: 26.3 g.

Analysis:

TGA: Observed weight loss: 46% corresponding to a solid content of 54 wt. %.

GPC: After refluxing with LiBr in THF at 65° C. (to cleave off the polymer from the sheet silicate): Mₙ=3700, M_{w}=7240, PDI=1.82.

Powder X-ray: No reflexions above 2Θ=30, corrsponding to an interlayer distance of >3 nm: complete exfoliation.

### EXAMPLE 3

A) A comb-copolymer of a poly(n-butyl acrylate) macromonomer (synthesized by ATRP) and dimethyl aminoethyl methacrylate (DMAEMA) is first synthesized according to known procedures (see e.g. WO-01/051534):

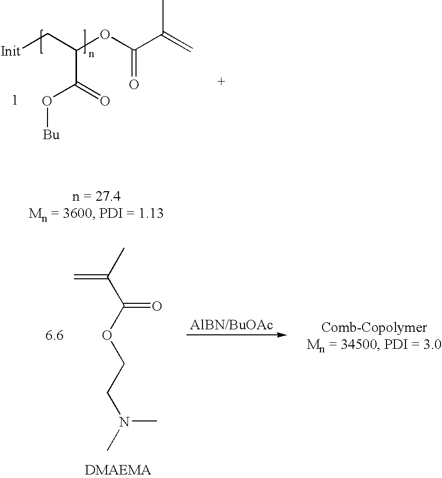

Synthesis of the poly(n-butyl acrylate) macromonomer (with methacrylate functional groups):

7.46 g (0.052 mol) Cu(I)Br is added into a 2.5 I reaction vessel (evacuated and rinsed with N₂ 5 times) followed by the addition of 1000 g (7.80 mol) n-butyl acrylate and 350 ml acetone. The reaction mature is homogenized by mechanical stirring. 9.0 g (0.052 mol) PMDETA are added with a syringe and a green solution is obtained. After adding 43.43 g (0.26 mol) methyl-2bromopropionate as the initiator, the mixture is heated to 60° C. The highly exothermic reaction requires cooling with ice to maintain the temperature at about 60° C. for4 h: Conversion: 74% (¹H-NMR analysis). The reaction mixture is cooled to room temperature and the solvents are evaporated in the rotary evaporator. After diluting the residue with 300 ml ethylacetate 2×150 g SiO₂ are added. The mixture is filtered and directly converted to the macromonomer as follows:

26.86 g (0.31 mol. 1.2 eq.) methacrylic acid and 47.51 g (0.31 mol. 1.2 eq.) DBU are ; added to the reaction mixture, which is then stirred at room temperature for 15 hours. After, filtration 200 g SiO₂ are added. The reaction mixture is stirred for a half hour and filtered, again. The solvents are evaporated in the rotary evaporator and the macromonomer dried at 100° C. in high vacuum (p<0.1 mbar). Yield: 803.3 g (97.5%) of a slightly yellow transparent viscous liquid. Analytical data:

| | C | H | Br |
|---|---|---|---|
| calc. | 65.06 | 9.30 | 0.00 |
| found | 64.79 | 9.68 | <0.3 |

GPC (THF, PS-standards): Mₙ: 3600, PDI=1.13.

Radical copolymerization of this macromonomer with N,N-dimethylaminoethyl methacrylate (DMAEA):

300 g (0.081 mol, 78 wt %) of above macromonomer, 84.6 9 (0.54 mol, 22 wt %) N,N-dimethylaminoethyl acrylate (DMAEMA), 640 ml 1-methoxy-2-propanol and 7.7 g (2 wt. %, relative to the monomers) AIBN, are introduced into a 1.51 reactor (evacuated and rinsed 3 times with N₂). The homogeneous mixture is polymerized at 60° C. (exothermic reaction) during 24 h. This mixture containing the comb-copolymer is directly used for tests as a pigment dispersant. Analytical data of dried sample:

| | C | H | N |
|---|---|---|---|
| calc. | 64.26 | 9.39 | 1.95 |
| found | 63.73 | 9.51 | 2.20 |

GPC (THF, PS-standards): Mₙ=34500, PDI=3.0.

This comb-polymer, containing 62 wt. % n-BA units and 38 wt. % DMAEMA units (according to ¹H-NMR) is neutralized in Dowanol PM with p-toluene sulfonic acid monohydrate as described in Examples 1 and 2 (100% of the amino groups are quaternised). A clear, slightly yellow solution with 29.8 wt. % solid content of the catlonic comb-copolymer is obtained.

B) Intercalation of a sheet silicate with a cationic comb-copolymer described under A) 513.7 g of the above solution containing 150 g of the cationic comb-copolymer A) is put into a 2 L round bottom flask with mechanical stirring and 500 g Dowanol PM and 100 g water are added 60.3 g Nanofil EXM 588 (Süd Chemie, Germany) is dispersed in this mixture with a high speed Ultraturax mixer, homogenized and stirred for 24 h at 60° C. It is than centrifuged (2000 rpm) during 1 h, the supernatend is decanted and the solid residue at the bottom is dispersed in 600 ml ethyl acetate and again centrifuged for 1 h at 2000 rpm. After again decanting the supernatend, the solid is redispersed in 600 ml EtOH with an Ultraturax and centrifuged again for 1 h. The gray solid is redispersed in 600 ml water, filtered, washed with EtOH and filtered again. The solid is dried in vacuum (0.1 mbar) at 50° C. for 24 h. Yield: 50.5 G.

Analysis:

TGA: Observed weight loss: 54% corresponding to a solid content of 46 wt. %.

GPC: After refluxing with LiBr in THF/water for 17 h at 65° C.: Mₙ=32800, M_{w}=61600, PDI=1.87.

Powder X-ray: No reflexions above 2Θ=3°, corrsponding to an interlayer distance of >3 nm: complete exfoliation.

### EXAMPLE 4

A) The same comb-copolymer of a poly(n-butyl acrylate) macromonomer (synthesized by ATRP) and dimethyl aminoethyl methacrylate (DMAEMA) as described in example 3 A) is used, but only 50% of the amino groups are neutralind in Dowanol PM with p-toluene sulfonic acid monohydrate. A dear, slightly yellow solution with 30.0 wt. % solid content of the cationic comb-copolymer is obtained.

B) intercalation of a sheet silicate with a cationic comb copolymer 213.5 g of above solution containing 64.05 g of the cationic comb-copolymer is put into a 1 L round bottom flask with mechanical stirring and 175 g Dowanol PM and 35 g water are added. 24.4 g Nanofil EXM 588 (Süd Chemie, Germany) is dispersed in this mixture with a high speed Ultraturax mixture, homogenized and stirred for 24 h at 60° C. It is then centrifuged (2000 rpm) during 1 h, the supernatend is decanted and the solid residue at the bottom is dispersed in ethyl acetate and again centrifuged for 1 h at 2000 rpm. After again decanting the supernatend, the solid is redispersed in EtOH with an Ultraturax and centrifuged again for 1 h. The gray solid is redispersed in water, filtered, washed with EtOH and filtered again. The solid is dried in vacuum (0.1 mbar) at 50° C. for 24 h. Yield: 27.5 g.

Analysis:

TGA: Observed weight loss: 49% corresponding to a solid content of 51 wt. %.

GPC: As in example 3, Mₙ=27100, M_{w}=45000, PDI=1.67.

Powder X-ray: No reflexions above 2Θ=3°, corresponding to an interlayer distance of >3 nm: complete exfoliation

C) intercalation of another sheet silicate (Harshaw Filtrol Grade 13) with a cationic comb-copolymer

492 g of the solution according to A) containing 137.3 g of the cationic comb-copolymer is put into a 2.5 L round bottom flask with mechanical stirring and 1.44 L Dowanol PM and 144 ml water are added. 120 g Harshaw Filtrol Grade 13 (Engelhard Process Chemicals GmbH, Nienburg, Germany) is dispersed in this mixture with a high speed Ultraturax mixture, homogenized and stirred for 24 h at 60° C. The solvents are evaporated in a rotavap and the solid residue extracted in a 1 L Soxhlet extractor, first 12 h with 2 L ethyl acetate, then 12 h with 2 L ethanol and finally 12 h with 2 L ethanol/water 1:1 mixture. The gray solid is redispersed in EtOH, filtered and dried in vacuum (0.1 mbar) at 55° C. for 24 h. Yield: 148.5 g.

Analysis:

TGA: Observed weight loss: 39 wt. % corresponding to a solid content of 61 wt. %.

Powder X-ray: No reflexions above 2Θ=30, corresponding to an interlayer distance of >3 nm: complete exfoliation.

1. A process for preparing a block- or comb polymer, clay nanocomposits dispersion comprising
mixing an aqueous dispersion of a natural or synthetic clay having an exchangeable cation; with
a block copolymer having a cationic block A wherein the cation is based on at least one nitrogen atom, and a nonionic block B, both blocks having a polydispersity between 1 and 3, or
a comb copolymer having a cationic backbone A wherein the cation is based on a nitrogen atom and nonionic oligomeric/polymeric chains B attached thereto, the cationic backbone A having a polydispersity between 1 and 3 and the nonionic side chains having a polydispersity of 1.0-1.8;
wherein the block copolymer is obtained
a1) by polymerizing in a first step an ethylenically unsaturated monomer in the presence of at least one nitroxylether having the structural element 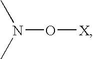
wherein X represents a group having at least one carbon atom and is such that the free radical X. derived from X is capable of initiating polymerization and adding in a second step to the resulting macromer, which has attached a labile bound 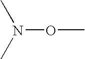
group, a further ethylenically unsaturated monomer different from that in step 1,
with the proviso that at least one monomer in the first or second step contains a cation centered on a nitrogen atom or a nitrogen atom from which a cation can be formed; or
a2) by polymerzing in a first step an ethylenically unsaturated monomer in the presence of at least one stable free nitroxyl radical 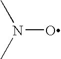
and a fee radical initiator and adding in a second step to the resulting macromer, which has attached a labile bound 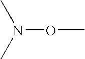
group, a further ethylenically unsaturated monomer different from that in step 1;
with the proviso that at least one monomer in the first or second step contains a cation centerd on a nitrogen atom or a nitrogen atom from which a cation can be formed; or
a3) by polymerzing in a first step an ethylenically unsaturated monomer in the presence of a compound of formula (III) 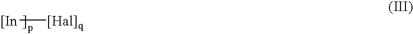
and a catalytically effective amount of an oxidizable transition metal complex catalyst, wherein
p represents a number greater than zero and defines the number of initiator fragments;
q represents a number greater than zero;
[In] represents a radically transferable atom or group capable of initiating polymerization and
-[Hal] represents a leaving group; and adding in a second step to the resulting macromer a further ethylenically unsaturated monomer different from that in step one;
with the proviso that at least one monomer in the first or second step contains a cation centered on a nitrogen atom or a nitrogen atom from which a cation can be formed;
wherein the comb copolymer is obtained
by polymerizing in a first step an ethylenically unsaturated monomer in the presence of a compound of formula (III) 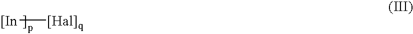
and a catalytically effective amount of an oxidizable translation metal complex catalyst, wherein the symbols have the meanings as defined above;
exchanging the group [HAL] attached to the polymer with a group having an ethylenically unsaturated bond and subjecting the resulting macromer together with a second monomer, which contains a nitrogen based cation or a nitrogen atom from which a cation can be formed, to radical polymerization;
forming the nitrogen based cation if necessary and exchanging the cation in the natural or synthetic clay with the nitrogen based cationic block or comb copolymer and intercalating and/or exfoliating the clay at least partially.

2. A process according to claim 1 wherein the natural or synthetic clay is a phyllosilicate.

3. A process according to claim 1 wherein the natural or synthetic clay is selected from the group consisting of smectite, montmorillonite, saponite, beidellite, mica, sauconite, ledikite, montronite, hectorite, stevensite, vermiculite, kaolinite, hallosite and combinations thereof.

4. A process according to claim 1 wherein the structural element 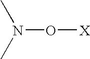
is a structural element of formula (I) 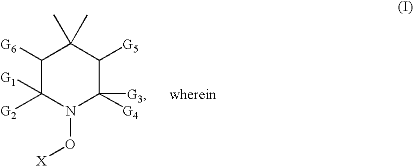
G₁, G₂, G₃, G₄ are independently C₁-C₈alkyl or G₁ and G₂ or G₃ and G₄, or G₁ and G₂ and G₃ and G₄ together form a C₅-C₁₂cycloalkyl group;
G₅, G₈ independently are H, C₁-C₁₈alkyl, phenyl, naphthyl or a group COOC₁-C₁₈alkyl.

5. A process according to claim 1 wherein the structural element 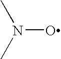
is a structural element of formula (I) 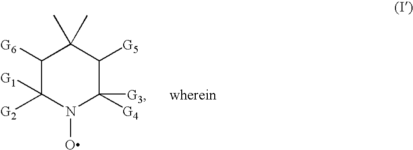
G₁, G₂, G₃, G₄ are independently C₁-C₆alkyl or G₁ and G₂ or G₃ and G₄, or G₁ and G₂ and G₃ and G₄ together form a C₅-C₁₂cycloalkyl group;
G₅, G₈ independently are H, C₁-C₁₈alkyl, phenyl, naphthyl or a group COOC₁-C₁₈alkyl.

6. A process according to claim 1, wherein in step a3)
[in] represents the polymerization initiator fragment of a polymerization initiator of formula (III) capable of initiating polymerization of monomers or oligomers which polymerization initiator is selected from the group consisting of C₁-C₈-alkyl halides, C₆-C₁₅-aralkylhalides, C₂-C₈-haloalkyl esters, arene sulfonyl chlorides, haloalkanenitriles, α-haloacrylates and halolactones, and
p and q represent one.

7. A process according to claim 6 wherein in step a3) the oxidizable transition metal in the transition metal complex salt is present as a transition metal complex ion in the lower oxidation state of a redox system.

8. A process according to claim 1, wherein the nonionic polymer block B is essentially composed of repeating units of ethylenically unsaturated monomers selected from the group consisting of styrenes, acrylic and C₁-C₄alkylacrylic acid C₁-C₂₄alkyl esters, acrylic and C₁-C₄alkylacrylic acid-C₈C₁₁aryl-C₁-C₄alkyl esters, acrylic and C₁-C₄alkylacrylic acid-C₈-C₁₁aryloxy-C₁-C₄alkyl esters, acrylic and C₁-C₄alkylacrylic acid-hydroxy-C₂-C₆alkyl esters, acrylic and C₁-C₄alkylacrylic acid-polyhydroxy-C₃-C₈alkyl esters, acrylic and C₁-C₄alkylacrylic acid-(C₁-C₄alkyl)₃silyloxy-C₂-C₄alkyl esters; acrylic and C₁-C₄alkylacrylic acid-(C₁-C₄alkyl)₃silyl-C₁-C₄alkyl esters, acrylic and C₁-C₄alkylacrylic acid-heterocyclyl-C₂-C₄alkyl esters; acrylic and C₁-C₄alkylacrylic acid esters having poly-C₂-C₄alkylene-glycolester groups, wherein the ester groups may be substituted with C₁-C₂₄alkoxy groups, acrylic and methacrylic acid amides, acrylic and C₁-C₄alkylacrylic acid-(C₁-C₄alkyl)₁₋₂amide, acrylonitrile, esters of maleic acid or fumaric acid, maleinimide and N-substituted maleinimides.

9. A process according to claim 8, wherein the nonionic polymer block B is essentially composed of repeating units of ethylenically unsaturated monomers selected from the group consisting of styrenes, acrylic and methacrylic acid-C₁-C₂₄alkyl esters, acrylic and methacrylic acid-hydroxy-C₂-C₆alkyl esters, acrylic and methacrylic acid-dihydroxy-C₃-C₄alkyl esters and acrylic and methacrylic acid esters having poly-C₂-C₄alkyleneglycolester groups, wherein the ester groups may be substituted with C₁-C₂₄alkoxy groups.

10. A process according to claim 1, wherein the cationic polymer block A is essentially composed of repeating units of ethylenically unsaturated monomers represented by the cationic part of a salt formed by quaternisation of an amino monomer selected from the group consisting of amino substituted styrene, (C₁-C₄alkyl)₁₋₂amino substituted styrene, N-mono-(C₁-C₄alkyl)₁₋₂amino-C₂-C₄alkyl(meth)acrylamide and N,N-di-(C₁-C₄alkyl)₁₋₂amino-(C₂-C₄)alkyl(meth)acrylamide, vinylpyridine or C₁-C₄alkyl substituted vinylpyridine, vinylimidazole and C₁-C₄alkyl substituted vinylimidazole and a compound of the formula
CH₂═C(—R¹)—C(═O)—R² (V),
wherein
R¹ represents hydrogen or C₁-C₄alkyl; and
R² represents amino substituted C₂-C₁₈alkoxy selected from the group consisting of amino-C₂-C₁₈alkoxy, C₁-C₄alkylamino-C₂-C₁₈alkoxy, di-C₁-C₄alkylamino-C₂-C₁₈alkoxy, hydroxy-C₂-C₄alkylamino-C₂-C₁₆alkoxy and C₁-C₄alkyl-(hydroxy-C₂-C₄alkyl)amino-C₂-C₁₈alkoxy.

11. A process according to claim 10, wherein
R¹ represents hydrogen or methyl; and
R² represents amino substituted C₂-C₁₈alkoxy selected from the group consisting of amino-C₂-C₄alkoxy, C₁-C₄alkylamino-C₂-C₄alkoxy, di-C₁-C₄alkylamino-C₂-C₄alkoxy, hydroxy-C₂-C₄alkylamino-C₂-C₁₈alkoxy and C₁-C₄alkyl-hydroxy-C₂-C₄alkyl)amino-C₂-C₄alkoxy.

12. A process according to claim 10, wherein the cationic part of a salt formed from a compound of the formula () is represented by an ester group of the formula (C) 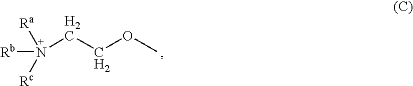
wherein
one of R^{a}, R^{b} and R^{c} represents 2-hydroxyethyl and the other ones represent hydrogen, methyl or ethyl; or
R^{a}, R^{b} and R^{c} independently of one another represent hydrogen or a substituent selected from the group consisting of C₁-C₄alkyl, aryl-C₁-C₄alkyl and (C₁-C₄alkyl)₁₋₃aryl.

13. A process according to claim 10, wherein the cationic polymer block A is essentially composed of repeating units of an ethylenically unsaturated monomer represented by the cationic part of an acid addition salt or the salt formed by quaternisation of 4-aminostyrene, 4-dimethylaminostyrene, aminoalkyl(meth)acrylate selected from the group consisting of 2-dimethylaminoethyl acrylate (DMAEA), 2-dimethylaminoethyl methacrylate (DMAEMA), 2-diethylaminoethyl acrylate (DEAEA), 2-diethylaminoethyl methacrylate (DEAEMA), 2-t-butylaminoethyl acrylate (t-BAEA), 2-t-butylaminoethyl methacrylate (t-BAEMA) and 3-dimethylaminopropylmethacrylamide, 4-vinylpyridine, 2-vinylpyridine or 1-vinylimidazole.

14. A process according to claim 1 wherein the block or comb copolymer is added to the natural or synthetic clay in an amount of from 1% to 1000% by weight, based on the w,ieight of the clay.

15. A process according to claim 1 wherein the polydispersity of block A and B is between 1 end 2.

16. A process according to claim 1 wherein the polydispersity of the blockcopolymer A-B is between 1 and 2.

17. A process according to claim 1 wherein the number of repeating units of the nonionic block B is from 4-1000.

18. A process according to claim 1 wherein the number of repeating units of the cationic block A is from 1-100.

19. A block or comb copolymer, clay nanocomposite dispersion obtainable by a process according to claim 1.

20. Use of a block copolymer having one ammonium cationic block A, and at least one neutral block B or a comb copolymer having an ammonium ion containing cationic backbone A and neutral oligomefic/polymeric chains B attached thereto, wherein the block copolymer and the comb copolymer is obtained by controlled free radical polymerization according to claim 1 for the preparation of nanocomposite dispersions of natural or synthetic clay.
